(19) United States
(12) Patent Application Publication
(10) Pub. No.: US 2026/0037867 A1
(43) Pub. Date: Feb. 5, 2026

(54) SYSTEM, APPARATUS, METHOD, AND NON-TRANSITORY COMPUTER READABLE MEDIUM

(71) Applicant: NEC Corporation, Minato-ku, Tokyo (JP)

(72) Inventors: Masayuki UEDA, Tokyo (JP); Katsunori DATE, Tokyo (JP); Kenji KAWAGUCHI, Tokyo (JP); Yoshinori WATANABE, Tokyo (JP); Hideki KOZUKA, Tokyo (JP); Rumi MATSUMURA, Tokyo (JP); Eiji TAKAHASHI, Tokyo (JP); Takeo ONISHI, Tokyo (JP)

(73) Assignee: NEC Corporation, Minato-ku, Tokyo (JP)

(21) Appl. No.: 19/101,075

(22) PCT Filed: Aug. 18, 2022
(86) PCT No.: PCT/JP2022/031252

§ 371 Date: Feb. 4, 2025

(51) Int. Cl. G06N 20/00

(52) U.S. Cl. CPC G06N 20/00

(57) ABSTRACT

A first system (10) includes an acquisition unit (11) that acquires data provided from a data providing apparatus such as an external server as inference data for a second system (20) to perform inference by an inference model, and a specifying unit (12) that specifies, from among data including the inference data 5acquired by the acquisition unit (11), data collected from the second system (20) that has performed inference by the inference model, as learning data for a learning model for constructing the inference model.

### TECHNICAL FIELD

The present disclosure relates to a system, an apparatus, a method, a program, and a non-transitory computer readable medium.

### BACKGROUND ART

In recent years, 5G (5th Generation) has been introduced as a radio communication technology for realizing large capacity, low delay, and multi-connectivity. In a next-generation radio communication system including 5G, in order to respond with an advanced and complicated system, a radio access network (RAN) is being opened, and in the open radio access network (O-RAN) alliance, opening of the RAN and intelligentization thereof are being discussed.

Patent Literature 1 related to the RAN describes that the RAN is controlled by utilizing artificial intelligence/machine learning (AI/ML) to distribute resources for learning. In addition, Non Patent Literature 1 related to the O-RAN describes a use case using Non-RT (real time) RIC and Near-RT RIC as a RAN intelligent controller (RIC) that intelligently controls the RAN by utilizing AI/ML. The Near-RT RIC is disposed near the E2 node including an O-RAN distributed unit (O-DU) and an O-RAN central unit (O-CU), and controls the RAN in real time. The Non-RT RIC is disposed at a place away from the E2node and controls the RAN in non-real time.

### CITATION LIST

### Patent Literature

Patent Literature 1: Japanese Unexamined Patent Application Publication No. 2021-141419

### Non Patent Literature

Non Patent Literature 1: O-RAN ALLIANCE, O-RAN Working Group 1, “Use Cases Detailed Specification”, Technical Specification, O-RAN. WG1. Use-Cases-Detailed-Specification-v08.00, 2022.04.04

### SUMMARY OF INVENTION

### Technical Problem

As described above, in Patent Literature 1, resources for learning can be distributed, and in Non Patent Literature 1, inference and learning can be performed by Non-RT RIC or Near-RT RIC. For example, according to Non Patent Literature 1, an inference model for inferring control of the RAN and a learning model for performing learning to construct the inference model can be arranged in any one of the Near-RT RIC and the Non-RT RIC, or can be arranged in a distributed manner. As a result, it is possible to perform learning by the learning model using the data being operated while executing control by the inference model. However, in order to perform learning by the learning model, it is necessary to collect learning data, and it is necessary to perform predetermined data processing on the collected data. Therefore, it may be difficult to efficiently perform learning.

In view of such problems, an object of the present disclosure is to provide a system, an apparatus, a method, and a non-transitory computer readable medium capable of efficiently performing learning.

### Solution to Problem

A system according to the present disclosure includes: an acquisition means for acquiring data provided from a data providing apparatus as inference data for another system to perform inference by an inference model; and a specifying means for specifying, from among data including the acquired inference data, data collected from the other system that has performed inference by the inference model, as learning data for a learning model for constructing the inference model.

A system according to the present disclosure includes: a collection means for collecting data provided from a data providing apparatus as inference data for performing inference by an inference model: and a transmission means for transmitting, as learning data for a learning model for constructing the inference model, data specified from among data including the collected inference data to another system that performs learning by the learning model.

An apparatus according to the present disclosure includes: an acquisition means for acquiring data provided from a data providing apparatus as inference data for another system to perform inference by an inference model: and a specifying means for specifying, from among data including the acquired inference data, data collected from the other system that has performed inference by the inference model, as learning data for a learning model for constructing the inference model.

An apparatus according to the present disclosure includes: a collection means for collecting data provided from a data providing apparatus as inference data for performing inference by an inference model; and a transmission means for transmitting, as learning data for a learning model for constructing the inference model, data specified from among data including the collected inference data to another system that performs learning by the learning model.

A method according to the present disclosure includes: acquiring data provided from a data providing apparatus as inference data for another system to perform inference by an inference model: and specifying, from among data including the acquired inference data, data collected from the other system that has performed inference by the inference model, as learning data for a learning model for constructing the inference model.

A method according to the present disclosure includes: collecting data provided from a data providing apparatus as inference data for performing inference by an inference model: and transmitting, as learning data for a learning model for constructing the inference model, data specified from among data including the collected inference data to another system that performs learning by the learning model.

A non-transitory computer readable medium according to the present disclosure is a non-transitory computer readable medium storing a program for causing a computer to execute: acquiring data provided from a data providing apparatus as inference data for another system to perform inference by an inference model: and specifying, from among data including the acquired inference data, data collected from the other system that has performed inference by the inference model, as learning data for a learning model for constructing the inference model.

A non-transitory computer readable medium according to the present disclosure is a non-transitory computer readable medium storing a program for causing a computer to execute: collecting data provided from a data providing apparatus as inference data for performing inference by an inference model; and transmitting, as learning data for a learning model for constructing the inference model, data specified from among data including the collected inference data to another system that performs learning by the learning model.

### Advantageous Effects of Invention

According to the present disclosure, it is possible to provide a system, an apparatus, a method, a program, and a non-transitory computer readable medium capable of efficiently performing learning.

### BRIEF DESCRIPTION OF DRAWINGS

FIG. 1 is a configuration diagram illustrating an outline of a first system according to an example embodiment.

FIG. 2 is a configuration diagram illustrating an outline of a second system according to an example embodiment.

FIG. 3 is a configuration diagram illustrating an outline of a first apparatus according to an example embodiment.

FIG. 4 is a configuration diagram illustrating an outline of a second apparatus according to an example embodiment.

FIG. 5 is a flowchart illustrating an outline of a first method according to an example embodiment.

FIG. 6 is a flowchart illustrating an outline of a second method according to an example embodiment.

FIG. 7 is a configuration diagram illustrating a configuration example of a RAN system according to a first example embodiment.

FIG. 8 is a diagram for describing a first collection scheme of learning data according to the first example embodiment.

FIG. 9 is a diagram for describing a second collection scheme of the learning data according to the first example embodiment.

FIG. 10 is a configuration diagram illustrating a configuration example of a Non-RT RIC according to the first example embodiment.

FIG. 11 is a diagram for describing a determination example of a collection scheme according to the first example embodiment.

FIG. 12 is a configuration diagram illustrating a configuration example of a Near-RT RIC according to the first example embodiment.

FIG. 13 is a flowchart illustrating an outline of an operation in the RAN system according to the first example embodiment.

FIG. 14 is a sequence diagram illustrating an operation example of inference phase processing according to the first example embodiment.

FIG. 15 is a sequence diagram illustrating another operation example of the inference phase processing according to the first example embodiment.

FIG. 16 is a sequence diagram illustrating an operation example of learning phase processing according to the first example embodiment.

FIG. 17 is a sequence diagram illustrating an operation example of inference phase processing according to a second example embodiment.

FIG. 18 is a sequence diagram illustrating an operation example of learning phase processing according to the second example embodiment.

FIG. 19 is a sequence diagram illustrating an operation example of inference phase processing according to a third example embodiment.

FIG. 20 is a sequence diagram illustrating an operation example of learning phase processing according to the third example embodiment.

FIG. 21 is a diagram for explaining a third collection scheme of learning data according to a fourth example embodiment.

FIG. 22 is a configuration diagram illustrating a configuration example of a RAN system according to a fifth example embodiment.

FIG. 23 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary.

For example, in a case where an inference model is arranged in a Near-RT RIC and a learning model is arranged in a Non-RT RIC, a method is considered in which the Near-RT RIC collects data such as radio quality from an E2 node for inference and the Non-RT RIC collects the same data from the E2 node for learning. Meanwhile, the inventor of the present disclosure has studied a study example in which data collected by the Near-RT RIC for inference is transferred from the Near-RT RIC to the Non-RT RIC as learning data.

According to Non Patent Literature 1, a use case is assumed in which external data is acquired from an external server outside the RAN and used for inference and learning together with data collected in the RAN. The inventor according to the present disclosure has found, in the above study examples, that there are the following problems if trying to collect external data for inference from the external server. That is, in this case, it is necessary to combine the data acquired from the external server and the data collected in the RAN and input the combined data to the learning model of the Non-RT RIC to execute the learning processing. In the synthesis processing, shaping processing such as matching a generation time of each data is necessary, and the processing takes time. Therefore, if the synthesis processing is performed by the Non-RT RIC, a load is applied to the Non-RT RIC. In addition, if the amount of data collected from the external server becomes enormous, a load of a network for transmitting data from the Near-RT RIC to the Non-RT RIC is large. For example, multimedia data such as image data and sensor data may be collected from an external server for inference. As described above, in the study example, a load may be applied to an apparatus that performs data processing or a load may be applied to a network that transmits data, and thus it is difficult to efficiently perform learning. Therefore, in an example embodiment, it is possible to reduce a load of an apparatus and a network and to efficiently perform learning.

### Outline of Example Embodiment

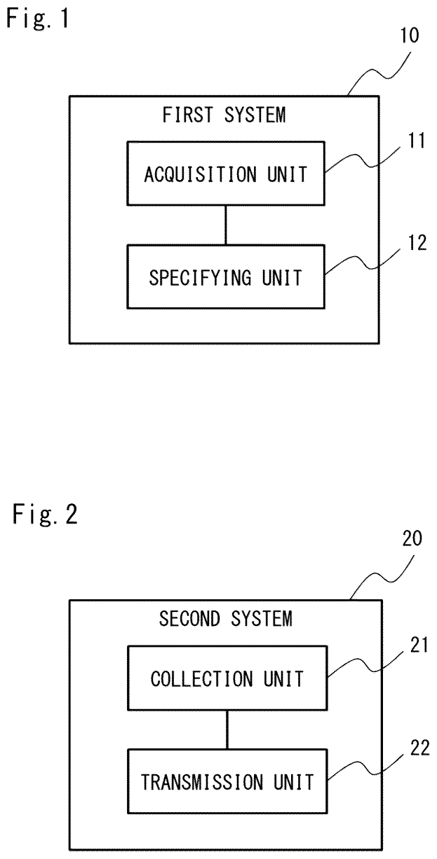

First, outlines of example embodiments will be described. FIG. 1 illustrates a schematic configuration of first system 10 according to an example embodiment, and FIG. 2 illustrates a schematic configuration of second system 20 according to an example embodiment. For example, the first system 10 and the second system 20 constitute a system that controls a radio network such as a RAN. For example, the first system 10 includes a Non-RT RIC and the second system 20 includes, but is not limited to, a Near-RT RIC.

As illustrated in FIG. 1, the first system 10 includes an acquisition unit 11 and a specifying unit 12. The acquisition unit 11 acquires data provided from a data providing apparatus as inference data for the second system 20 to perform inference by the inference model. For example, the data providing apparatus is a server outside the system including the first system 10 and the second system 20. In a case where the first system 10 and the second system 20 control the RAN, the data providing apparatus is a server outside the RAN. The data provided from the external data providing apparatus is data outside the RAN, such as weather information and traffic information. The inference model infers control related to a radio network such as a RAN by inference data, for example. The control related to the radio network is, for example, control of the operation of the RAN, and is control of a radio schedule, a beam, and the like that can be performed by setting an E2 node.

The specifying unit 12 specifies data collected from the second system 20 inferred by the inference model as learning data for the learning model for constructing the inference model. For example, the specifying unit 12 specifies data to be collected as learning data from among data including inference data acquired from the data providing apparatus. For example, the learning model learns control related to a radio network such as a RAN by learning data. The learning model is, for example, included in the first system 10, but may be located outside of the first system 10. It can also be said that specifying data to be collected as learning data is to determine a collection scheme for collecting the specified data. The specifying unit 12 may specify whether to collect data acquired from the data providing apparatus from the second system 20. For example, in a case where external data acquired from an external server and RAN data acquired from the E2 note are used for inference of the inference model, the specifying unit 12 specifies data to be collected from data including the external data and the RAN data used for inference.

In addition, the first system 10 may include a transfer unit that transfers the inference data acquired from the data providing apparatus to the second system 20, and the specifying unit 12 may specify whether to collect the inference data transferred to the second system 20 from the second system. In addition, the first system 10 may include a storage unit that stores the inference data transferred to the second system 20, and the specifying unit 12 may specify whether to collect the inference data stored in the storage unit from the second system. In addition, the first system 10 may include a synthesis unit that combines the inference data stored in the storage unit and the data collected from the second system 20 to generate the learning data to be input to the learning model in a case where the inference data from the data providing apparatus is not collected from the second system 20.

For example, the specifying unit 12 may specify the data to be collected based on the feature of the inference data acquired from the data providing apparatus. In addition, the specifying unit 12 may specify data to be collected based on an instruction input from an operator or a load of a RAN system including the first system 10 and the second system 20.

As illustrated in FIG. 2, the second system 20 includes a collection unit 21 and a transmission unit 22. The collection unit 21 collects data provided from the data providing apparatus as inference data for performing inference by the inference model. For example, the collection unit 21 collects external data provided from an external server via the first system 10. The inference model is, for example, included in the second system 20, but may be located outside of the second system 20. For example, the inference model infers RAN control according to external data obtained via the first system 10 and RAN data such as radio quality collected from the E2 nodes.

The transmission unit 22 transmits the data specified as the learning data for the learning model of the first system 10 to the first system 10 that performs learning by the learning model. The transmission unit 22 transmits data specified from among the data including the inference data collected by the collection unit 21. For example, data specified by the first system 10 from data including external data and RAN data used for inference is transmitted to the first system 10.

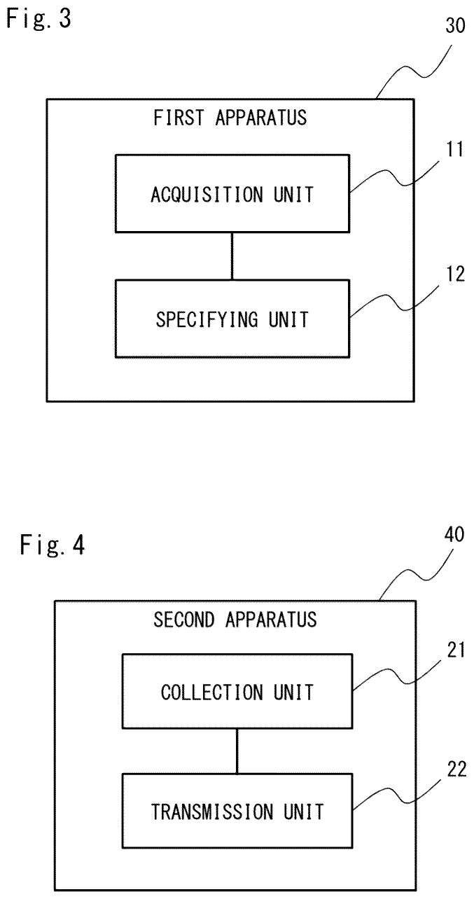

Note that each of the first system 10 and the second system 20 may include one apparatus or a plurality of apparatuses. FIG. 3 illustrates a configuration example of a first apparatus 30 according to an example embodiment, and FIG. 4 illustrates a configuration example of a second apparatus 40 according to an example embodiment. As illustrated in FIG. 3, the first apparatus 30 may include the acquisition unit 11 and the specifying unit 12 illustrated in FIG. 1. The present disclosure is not limited to this example, and the acquisition unit 11 and the specifying unit 12 may be mounted on another apparatus. As illustrated in FIG. 4, the second apparatus 40 may include the collection unit 21 and the transmission unit 22 illustrated in FIG. 2. The present disclosure is not limited to this example, and the collection unit 21 and the transmission unit 22 may be mounted on another apparatus. As with the first system 10 and second system 20, for example, the first apparatus 30 may be a Non-RT RIC, and the second apparatus 40 may be a Near-RT RIC.

In addition, some or all of the first system 10 and the second system 20 may be arranged on an edge or a cloud by using a virtualization technology or the like. They may be arranged at specific places or may be arranged in a plurality of places in a distributed manner. The edge is a place or a base on the base station side including an O-DU and an O-CU. The cloud is a place or infrastructure on a core network side away from a base station. For example, the acquisition unit 11 and the specifying unit 12 may be arranged in a cloud, and the collection unit 21 and the transmission unit 22 may be arranged the edge. In addition, the acquisition unit 11, the specifying unit 12, the collection unit 21, and the transmission unit 22 may be arranged in a distributed manner.

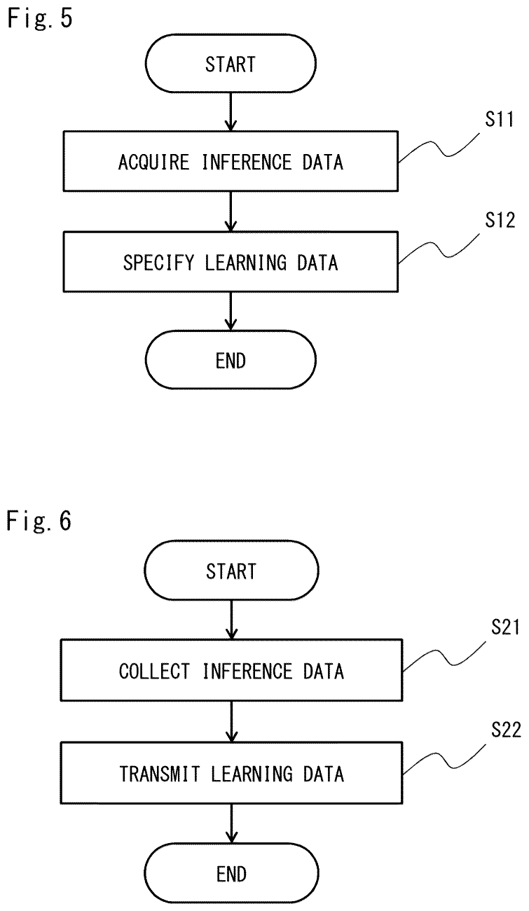

FIG. 5 illustrates a first method according to an example embodiment, and FIG. 6 illustrates a second method according to an example embodiment. For example, the first method is performed by the first system 10 in FIG. 1 or the first apparatus 30 in FIG. 3. The second method is performed by the second system 20 in FIG. 2 or the second apparatus 40 in FIG. 4.

As illustrated in FIG. 5, the acquisition unit 11 acquires data provided from the data providing apparatus as inference data for the second system 20 to perform inference by the inference model (S11). Next, the specifying unit 12 specifies data collected from the second system 20 that has performed inference by the inference model from among data including the acquired inference data as learning data to be used by the learning model (S12). For example, the first system 10 transfers the inference data acquired from the data providing apparatus to the second system 20.

In addition, as illustrated in FIG. 6, the collection unit 21 collects inference data for performing inference by an inference model (S21). For example, the inference data provided from the data providing apparatus is acquired via the first system 10. Next, the transmission unit 22 transmits, as learning data for the learning model of the first system 10, data specified from among data including the collected inference data to the first system 10 that performs learning by using the learning model (S22). The transmission unit 22 transmits the data specified by the first system 10 to the first system 10 as learning data. For example, the first system 10 performs learning by the learning model using the learning data collected from the second system 20, and applies the learned learning model to the inference model of the second system 20.

As described above, in the example embodiments, the first system such as the Non-RT RIC acquires the inference data for the inference model, and specifies the data collected from the second system such as the Near-RT RIC as the learning data used by the learning model. In addition, the second system acquires inference data from the first system or the like, and transmits data specified by the first system or the like as learning data used by the learning model. By specifying the data collected from the Non-RT RIC by the Near-RT RIC, it is possible to select a system or an apparatus that performs data processing such as synthesis of learning data, and thus, it is possible to reduce a load due to the data processing, and it is possible to adjust the amount of data to be transferred, and thus, it is possible to reduce a load of a network that transfers data. Therefore, learning can be efficiently performed.

### First Example Embodiment

Next, a first example embodiment will be described. In the present example embodiment, an example will be described in which a Non-RT RIC acquires external data from an external server, and switches a collection scheme of learning data according to a feature or the like of the data.

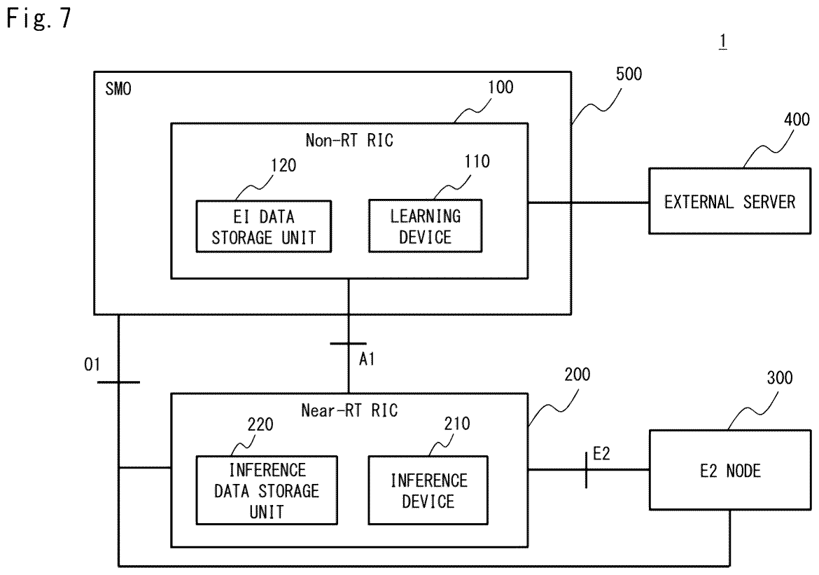

FIG. 7 illustrates a configuration example of a RAN system I according to the present example embodiment. As illustrated in FIG. 7, the RAN system 1 according to the present example embodiment includes a Non-RT RIC 100, a Near-RT RIC 200, an E2 node 300, and an external server 400. The Non-RT RIC 100 is disposed in a service management and orchestration (SMO) 500 that manages and orchestrates the RAN. Note that the functions included in the SMO 500 may be described as the functions of the Non-RT RIC 100.

The SMO 500 and the Near-RT RIC 200 and the SMO 500 and the E2 node 300 are communicatively connected via an O1 interface. It can also be said that the Non-RT RIC 100 and the Near-RT RIC 200 and the Non-RT RIC 100 and the E2 node 300 are communicably connected via the O1 interface via the SMO 500. Note that the description may be given assuming that the Non-RT RIC 100 and the Near-RT RIC 200 are connected to each other and the Non-RT RIC 100 and the E2 node 300 are connected to each other via the O1 interface. The O1 interface is an interface for transmitting and receiving data and messages mainly necessary for operation and management. Note that the interface is a connection interface defined by a communication protocol for transmitting and receiving data and messages, and includes a logical transmission path, a network, a physical transmission path, and a network.

The Non-RT RIC 100 and the Near-RT RIC 200 are communicably connected via an A1 interface. The Near-RT RIC 200 and the E2 node 300 are connected via an E2 interface. The A1 interface and the E2 interface are interfaces for mainly transmitting and receiving data and messages necessary for control.

In the O-RAN, a policy management service (A1-P), an enrichment information service (A1-EI), and an ML model management service (A1-ML) are defined as services provided by the A1 interface. In the policy management service, the Non-RT RIC provides the Near-RT RIC with guidance for RAN optimization, that is, an A1 policy. The A1 policy is a control policy related to control of the RAN. In the enrichment information service, enrichment information that cannot be collected in the RAN is made available in the Near-RT RIC, thereby optimizing the performance of the RAN. In the ML model management service, the Non-RT RIC provides enrichment information in order to support inference using an inference model in the Near-RT RIC. In the present example embodiment, enrichment information is transferred from Non-RT RIC to Near-RT RIC at the time of inference of Near-RT RIC by using the enrichment information service of the A1 interface. Note that enrichment information is also referred to as EI data.

Since the Non-RT RIC 100 and the external server 400 are not defined by the O-RAN, they are communicably connected via an arbitrary interface. The interface between the Non-RT RIC 100 and the external server 400 may be an interface for a general application server to provide data. For example, a hypertext transfer protocol (HTTP) for a web server or another application programming interface (API) may be used.

The E2 node 300 is a node constituting the RAN and includes an O-DU and an O-CU. The RAN is a radio network accessed by user equipment (UE), and is connected to a core network such as a 5G core network (5GC) or an evolved packet core (EPC). The RAN may include an O-RAN remote unit (O-RU) constituting an antenna. The UE is a terminal device that is connected to the RAN and performs radio communication, and may be a mobile phone, a smartphone, a tablet terminal, an Internet of Things (IoT) terminal, or the like. The UE may be an application device such as a robot, a drone, or a self-driving vehicle that implements a function of a terminal.

The E2 node 300 including the O-DU and the O-CU provides a base station function. The base station is, for example, a next generation node B (gNB) or an evolved node B (eNB), but is not limited thereto. Note that the O-DU and the O-CU are examples of nodes that provide the base station function, and may be other network nodes.

The O-DU is a logical node that provides a radio signal control function and a layer 2 control function of the base station. The O-DU accommodates the O-RU and performs control of a radio signal (beam) of an antenna in the O-RU to the accommodated O-RU and protocol processing such as media access control (MAC) or radio link control (RLC) necessary between the O-RU and the O-CU.

The O-CU is a logical node that provides a radio resource control function of the base station and a data processing function higher than the layer 2. The O-CU accommodates the O-DU and performs protocol processing such as data transmission/reception via the O-DU to the accommodated O-DU, quality of service (QOS) control, cell/UE management, handover control, packet data convergence protocol (PDCP) required between the O-DU and the core network, service data adaptation protocol (SDAP), and radio resource control (RRC).

The E2 node 300 may include any number of O-DUs and O-CUs of 1 or more. That is, a plurality of base stations may be included. In addition, the E2 node 300 may be implemented by a virtual machine operating on a virtualization base of an edge. The base of the edge may be a multi-access edge computing (MEC). The O-DU and the O-CU may be a virtualized distributed unit (vDU) and a virtualized central unit (vCU), and may constitute a virtual base station. The O-DU and the O-CU may be physical DU and CU. In addition, the E2 node 300 may be a base station apparatus including functions of an O-DU and an O-CU.

The external server 400 is a server outside the RAN including at least the E2 node 300. The external server 400 can also be said to be a server outside the system including the E2 node 300, the Non-RT RIC 100, and the Near-RT RIC 200. The external server 400 is a data providing apparatus that provides enrich information (EI) data. The EI data is external data that is defined by the A1 interface as described above and cannot be collected inside the RAN, and is also inference data used for inference by the inference model of the Near-RT RIC 200. The external server 400 includes an application server that provides various data that can be used to infer the inference model. For example, the external server 400 may be a web server or a social networking service (SNS) server. The EI data is, for example, weather information, traffic information, map information, or the like. The external server 400 only needs to be able to provide the EI data to the Non-RT RIC 100, and may be, for example, a server on the Internet. The external server 400 may be a physical server or a virtual server on a cloud.

The Near-RT RIC 200 is a logical function that controls and optimizes the RAN in real time. The Near-RT RIC 200 controls the RAN with a short control cycle of, for example, 1 s or less. The Near-RT RIC 200 collects and analyzes RAN data from the E2 node 300 via the E2 interface and controls the E2 node according to the RAN data. Furthermore, in the present example embodiment, the Near-RT RIC 200 collects the EI data from the external server 400 via the A1 interface and the Non-RT RIC 100, and controls the E2 node according to the EI data and the RAN data. For example, the Near-RT RIC 200 performs control according to the EI data and the RAN data according to the control policy acquired from the Non-RT RIC 100, that is, the A1 policy via the A1 interface. The RAN data is radio related data related to radio of the RAN, includes radio quality data and location information for each UE, and may include the number of active UEs for each base station (cell). For example, the radio quality data may be acquired from the O-DU, or the information related to the handover may be acquired from the O-CU. The Near-RT RIC 200 is disposed at the same place as the E2 node 300 or near the E2 node 300. For example, the Near-RT RIC 200 may be implemented in a virtual machine at the same edge as that of the E2 node 300.

Some functions of the Near-RT RIC 200 are implemented by xApp (Near-RT RIC Application). The xApp includes an application for analyzing and inferring the RAN data and the EI data. For example, the xApp includes an inference device (inferencer) 210 that performs inference by an inference model that is a learned model. The inference device 210 analyzes inference data including the RAN data and the EI data and controls the RAN by the inference model. Furthermore, the Near-RT RIC 200 includes an inference data storage unit 220 that stores inference data including EI data and RAN data used for inference by the inference device 210.

The Non-RT RIC 100 is a logical function that controls and optimizes the RAN in non-real time. The Non-RT RIC 100 controls the RAN with a long control cycle of, for example, 1 s or more. The Non-RT RIC 100 manages a control policy, manages operations of the E2 node 300 and the Near-RT RIC 200, learns (trains) a learning model, updates an inference model, and the like. For example, the Non-RT RIC 100 generates a control policy and notifies the Near-RT RIC 200 of the generated control policy via the A1 interface. In addition, the Non-RT RIC 100 manages and sets configuration information (Configuration) of the E2 node 300 based on data acquired from the E2 node 300 or the Near-RT RIC 200 via the O1 interface. Further, the Non-RT RIC 100 acquires the EI data from the external server 400 and transfers the acquired EI data to the Near-RT RIC 200. The Non-RT RIC 100 and the SMO 500 are disposed at a place away from the E2 node 300 and the Near-RT RIC 200, for example, on a cloud.

Some functions of the Non-RT RIC 100 are implemented by a Non-RT RIC application (rApp). The rApp includes an application that generates a control policy, manages an inference model of the Near-RT RIC 200, and the like. For example, the rApp includes a learning device (learner) 110 that performs learning using a learning model. The learning device 110 generates a learning model having learned the control of the RAN using the learning data acquired from the E2 node 300 or the Near-RT RIC 200 via the O1 interface, and applies the generated learned learning model to xApp of the Near-RT RIC 200. Note that applying a learned learning model to the inference model is also referred to as deployment. The deployment is to place and deploy the model in an execution environment of the application and make the model executable. In addition, the Non-RT RIC 100 includes an EI data storage unit 120 that stores the EI data acquired from the external server 400.

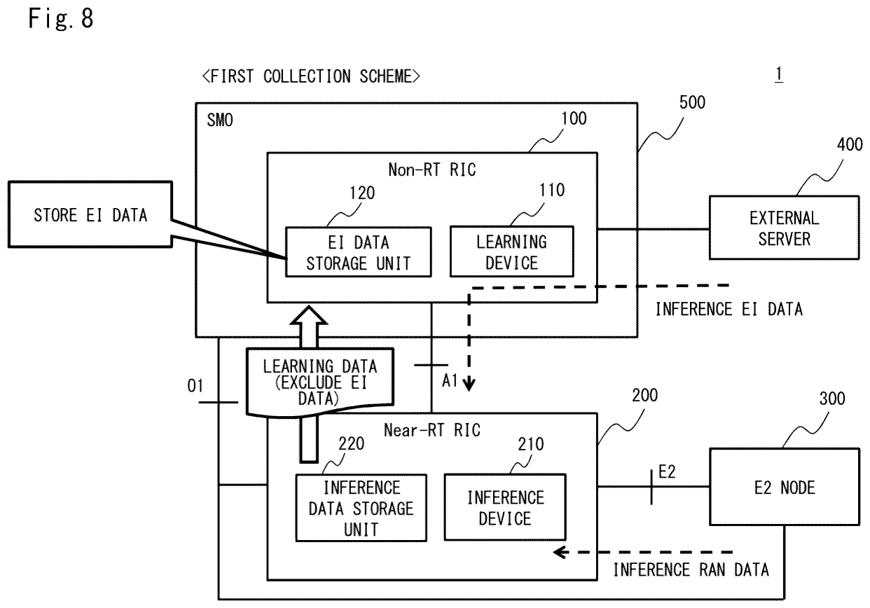

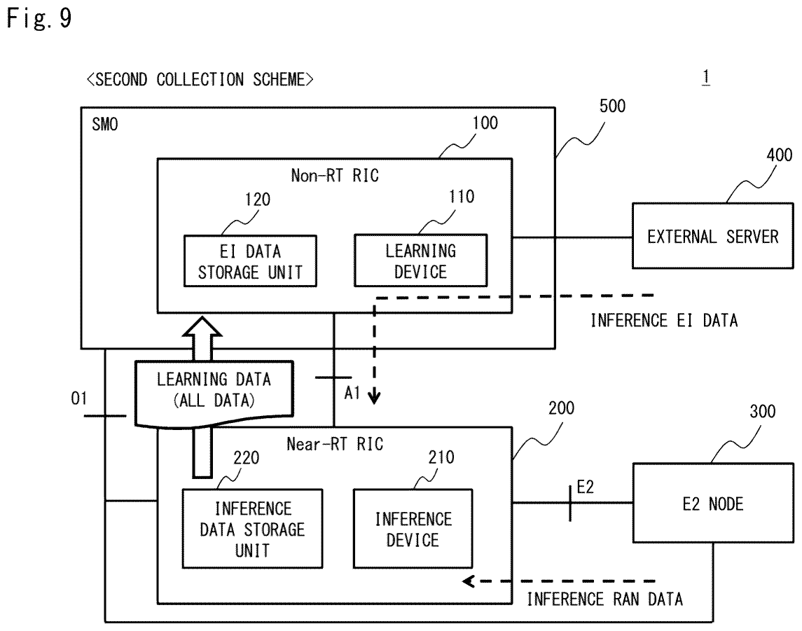

FIG. 8 illustrates a first collection scheme (collection scheme 1) of learning data according to the present example embodiment, and FIG. 9 illustrates a second collection scheme (collection scheme 2) of learning data according to the present example embodiment. In the present example embodiment, the Non-RT RIC 100 collects the learning data from the Near-RT RIC 200 by the first collection scheme or the second collection scheme. It can also be said that the learning data is transferred from the Near-RT RIC 200 to the Non-RT RIC 100 by any scheme.

As illustrated in FIG. 8, the first collection scheme is a method of transferring the reduced weight data from the Near-RT RIC 200 to the Non-RT RIC 100. As a result, the load on the O1 interface can be reduced.

In the first collection scheme, at the time of inference, the Non-RT RIC 100 acquires EI data for inference from the external server 400, stores the acquired EI data in the EI data storage unit 120, and transfers the acquired EI data to the Near-RT RIC 200. The Near-RT RIC 200 performs inference by the inference device 210 using the EI data acquired from the Non-RT RIC 10 and the RAN data collected from the E2 node 300 as the inference data, and stores the inference data used for the inference in the inference data storage unit 220.

In addition, in the first collection scheme, at the time of learning, in a case where transferring the inference data stored in the inference data storage unit 220 to the Non-RT RIC 100 as the learning data, the Near-RT RIC 200 transfers, to the Non-RT RIC 100, the reduced weight data obtained by removing the EI data stored in the Non-RT RIC 100. The Non-RT RIC 100 combines the reduced learning data collected from the Near-RT RIC 200 and the EI data stored in the EI data storage unit 120, and performs learning by the learning device 110 using the combined learning data.

As illustrated in FIG. 9, the second collection scheme is a scheme of transferring all data necessary for learning from the Near-RT RIC 200 to the Non-RT RIC 100. As a result, the processing load of the Non-RT RIC 100 can be reduced.

In the second collection scheme, at the time of inference, the Non-RT RIC 100 acquires EI data for inference from the external server 400, and transfers the acquired EI data to the Near-RT RIC 200 without storing the acquired EI data in the EI data storage unit 120. The Near-RT RIC 200 performs inference by the inference device 210 using the EI data acquired from the Non-RT RIC 10 and the RAN data collected from the E2 node 300 as the inference data, and stores the inference data used for the inference in the inference data storage unit 220.

In addition, in the second collection scheme, at the time of learning, the Near-RT RIC 200 transfers all the pieces of inference data including the EI data and the RAN data stored in the inference data storage unit 220 to the Non-RT RIC 100 as the learning data. The Non-RT RIC 100 performs learning by the learning device 110 using the learning data including all the received data.

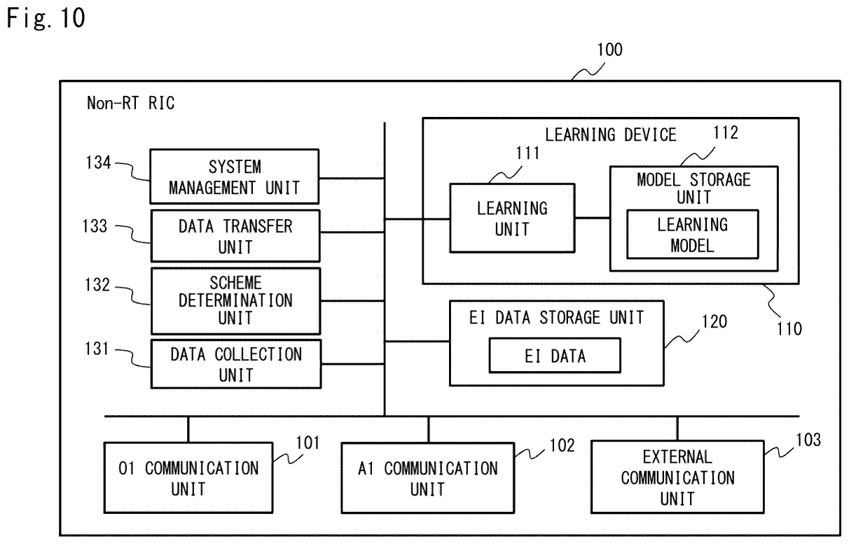

FIG. 10 illustrates a configuration example of the non-RT RIC 100 according to the present example embodiment. As illustrated in FIG. 10, the Non-RT RIC 100 includes the learning device 110 and the EI data storage unit 120. For example, the learning device 110 includes a learning unit 111 and a model storage unit 112. In addition, the Non-RT RIC 100 includes an O1 communication unit 101, an A1 communication unit 102, an external communication unit 103, a data collection unit 131, a scheme determination unit 132, a data transfer unit 133, and a system management unit 134. The O1 communication unit 101 may be included in the SMO 500. Note that the configuration is an example, and another configuration may be used as long as the operation according to the present example embodiment described below can be performed. In addition, a configuration for realizing a function necessary for the Non-RT RIC may be included.

The O1 communication unit 101 is a communication unit that communicates with the Near-RT RIC 200 via the O1 interface. For example, the O1 communication unit 101 transmits and receives various data including learning data, control messages, and the like to and from the Near-RT RIC 200 according to a communication scheme defined as the O1 interface. It is also possible to transmit and receive necessary data and control messages to and from the E2 node 300 via the O1 interface.

The A1 communication unit 102 is a communication unit that communicates with the Near-RT RIC 200 via the A1 interface. For example, the A1 communication unit 102 transmits and receives various data including EI data, a control message including a control policy, and the like to and from the Near-RT RIC 200 according to a communication scheme defined as the A1 interface.

The external communication unit 103 is a communication unit that communicates with the external server 400 via an arbitrary interface. For example, the external communication unit 103 acquires the EI data from the external server 400 according to a predetermined communication scheme such as HTTP.

The data collection unit 131 collects data necessary for learning, management, transfer, and the like from the external server 400, the Near-RT RIC 200, and the E2 node 300. At the time of inference, EI data is acquired from the external server 400 via the external communication unit 103 according to an instruction from the Near-RT RIC 200. For example, the data collection unit 131 and the external communication unit 103 correspond to the acquisition unit 11 in FIG. 1. In addition, at the time of learning, learning data transferred from the Near-RT RIC 200 is collected via the O1 interface through the O1 communication unit 101. In addition, necessary data is also collected from the E2 node 300.

The scheme determination unit 132 determines the collection scheme of the learning data illustrated in FIGS. 8 and 9. It can also be said that the scheme determination unit 132 specifies data to be collected from the Near-RT RIC 200 by determining the collection scheme. For example, the scheme determination unit 132 corresponds to the specifying unit 12 in FIG. 1.

For example, the scheme determination unit 132 determines the collection scheme based on the features of the EI data captured for inference from the external server 400 at the time of inference. Determining the collection scheme is also selecting the collection scheme. Every time the EI data is acquired from the external server 400, the scheme determination unit 132 may determine the collection scheme based on the feature of the acquired EI data. Further, the scheme determination unit 132 may determine the collection scheme based on the feature of the acquired EI data at a specific timing such as a timing at which the EI data is first acquired from the external server 400 in response to a request from the Near-RT RIC 200. The collection scheme may be determined every time the EI data is acquired a predetermined number of times, or the collection scheme may be determined every time a predetermined time elapses.

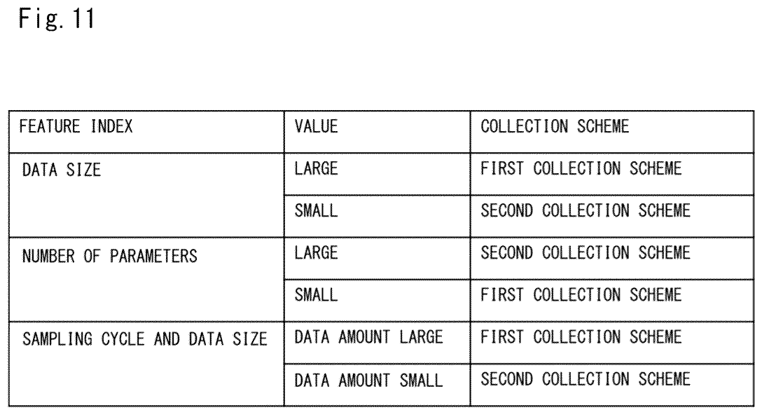

FIG. 11 illustrates a specific example of determining the collection scheme based on the feature of the data. As illustrated in FIG. 11, the collection scheme is determined based on a feature index indicating the feature of data. The feature index includes, for example, a data size, the number of parameters, and a sampling cycle, but is not limited thereto, and other indexes may be used. In addition, the collection scheme may be determined by any one of the feature indexes of the data size, the number of parameters, and the sampling cycle, or the collection scheme may be determined by combining arbitrary feature indexes. For example, the collection scheme may be determined based on the sampling cycle and the data size. In addition, the collection scheme may be determined based on the sampling cycle, the data size, and the number of parameters.

In the example in which the data size is used, the scheme determination unit 132 selects the first collection scheme or the second collection scheme according to whether the data size is large or small. Specifically, in a case where the data size of the acquired EI data is large, the first collection scheme for storing the EI data in the Non-RT RIC 100 is selected. In a case where the data size of the EI data has a large proportion in the entire learning data, it is determined that it is appropriate to reduce the amount of transfer from the Near-RT RIC 200 to the Non-RT RIC 100 by the first collection scheme. For example, in a case where the data size of the EI data is larger than a predetermined threshold value, the first collection scheme is selected. A total data size necessary for learning may be acquired from a learning device or the like, and the first collection scheme may be selected in a case where a ratio of the EI data to the total data size is larger than a predetermined threshold value. Examples of the EI data having a large data size are image data, a vast range or highly accurate map information, and the like. Note that, since it is assumed that the data size is large in the case of these pieces of data, the first collection scheme may be selected in a case where the data type of the EI data is map information, multimedia data, or the like.

Meanwhile, in a case where the data size of the acquired EI data is smaller than the predetermined threshold value, the scheme determination unit 132 selects the second collection scheme in which the Non-RT RIC 100 does not need to store the EI data. In a case where the ratio of the EI data to the entire data size necessary for learning is smaller than a predetermined threshold value, the second collection scheme may be selected. In a case where the data size of the EI data is small, the effect of reducing the amount of transfer from the Near-RT RIC 200 to the Non-RT RIC 100 is small. Therefore, it is determined that it is more appropriate to suppress a processing cost of combining the data collected from the Near-RT RIC 100 and the EI data stored in the Non-RT RIC 200 as the learning data to be used in the Non-RT RIC 100, and the data used for inference in the Near-RT RIC 200 is used as it is for learning. Examples of the EI data having a small data size include time-series log data of a specific application, log data of a sensor device, and the like. In the case of these pieces of data, since it is assumed that the data size is small, the second collection scheme may be selected in a case where the data type of the EI data is log data, text data, or the like.

In addition, in the example of using the number of parameters, the scheme determination unit 132 selects the first collection scheme or the second collection scheme according to whether the number of parameters is large or small. Specifically, in a case where the number of parameters of the acquired EI data is larger than a predetermined threshold value, the second collection scheme is selected. The number of parameters is the number of parameters constituting the EI data, and is, for example, the number of variables or the number of data. For example, in a case where the number of parameters is enormous as in the sensor data of the camera, it is determined that it is more appropriate to suppress the processing cost of combining the data collected from the Near-RT RIC 100 and the EI data stored in the Non-RT RIC 200 as the learning data to be used in the Non-RT RIC 100.

Meanwhile, in a case where the number of parameters of the acquired EI data is smaller than the predetermined threshold value, the scheme determination unit 132 selects the first collection scheme. For example, in a case where the number of parameters of the EI data is small, since the processing cost for combining the data collected from the Near-RT RIC 200 and the EI data stored in the Non-RT RIC 100 as the learning data to be used in the Non-RT RIC 100 is small, it is determined that it is appropriate to reduce the amount of transfer from the Near-RT RIC 200 to the Non-RT RIC 100.

In this example, in a case where the sampling cycle is used, the scheme determination unit 132 determines the collection scheme based on the sampling cycle and the data size. For example, the first collection scheme or the second collection scheme is selected according to whether the data amount depending on the sampling cycle and the data size is large or small. Note that the collection scheme may be determined based on only the sampling cycle. The sampling cycle is a data collection cycle, a collection interval, or the number of times of collection in a predetermined period. Specifically, the total amount of data or the amount of data collected in a predetermined period is calculated from the data size and the sampling cycle. In a case where the calculated total data amount or the data amount in the predetermined period is larger than a predetermined threshold value, the first collection scheme is selected. For example, even in a case where the data size is small, the final data size is increased in a case where data is collected in a short cycle. In this case, since the proportion in the entire learning data increases, it is determined that it is appropriate to select the first collection scheme and reduce the amount of transfer from the Near-RT RIC 200 to the Non-RT RIC 100.

Meanwhile, in a case where the data amount calculated from the data size and the sampling cycle is smaller than the predetermined threshold value, the scheme determination unit 132 selects the second collection scheme. Even in a case where the data size is large, in a case where the data is collected in a long cycle, the effect of reducing the amount of transfer from the Near-RT RIC 200 to the Non-RT RIC 100 is small, and thus, the second collection scheme is selected.

In this manner, one of the collection schemes is selected based on the feature of the data so that the learning processing can be efficiently performed in the entire system including the Non-RT RIC 100 and the Near-RT RIC 200. Note that, as illustrated in FIG. 11, the feature index and the collection scheme may be associated in advance, and the collection scheme may be determined based on a rule based on an associated table or the like, or a relationship between the feature index and the optimum collection scheme may be machine-learned, and the collection scheme may be determined on a machine learning basis using the learned learning model.

Note that the scheme determination unit 132 may determine the collection scheme under other conditions without being limited to the feature of the EI data. For example, the collection scheme may be switched based on an instruction from an operator or the like. In addition, the collection scheme may be set for each time zone, and the collection scheme may be switched according to time. Further, the collection scheme may be selected according to the load of the RAN system 1. For example, the system management unit 134 may determine the load of each apparatus or each interface based on the data collected from the E2 node 300 or the Near-RT RIC 200, and select the collection scheme according to the determined load. In a case where the load of the O1 interface is large, the first collection scheme may be selected to suppress the load of the O1 interface. In a case where the load of the Non-RT RIC 100 is large, the second collection scheme may be selected to suppress the load of the Non-RT RIC 100.

The data transfer unit 133 transfers the EI data for inference acquired from the external server 400 to the Near-RT RIC 200 via the A1 interface via the A1 communication unit 102. In addition, at the time of transfer, the acquired EI data is stored in the EI data storage unit 120 according to the collection scheme determined by the scheme determination unit 132. The scheme determination unit 132 notifies the Near-RT RIC 200 of the collection scheme corresponding to the EI data by transmitting the determined collection scheme together with the EI data to be transferred.

The system management unit 134 manages settings and operations of the RAN system including the E2 node 300 and the Near-RT RIC 200. The function of the system management unit 134 may be realized by executing rApp for system management processing. For example, the system management unit 134 is a policy generation unit that generates a control policy. The system management unit 134 may generate the control policy based on an instruction input from an operator or an external apparatus, or may generate the control policy based on data acquired from the E2 node 300 and the Near-RT RIC 200. The system management unit 134 notifies the Near-RT RIC 200 of the generated control policy via the A1 interface through the A1 communication unit 102.

The model storage unit 112 stores a learning model for constructing an inference model of the Near-RT RIC 200. The learning model learns the control of the RAN according to the RAN data and the EI data. The learning model is, for example, a model that performs learning so as to analyze and predict time-series data. The learning model may be a convolutional neural network (CNN), a recurrent neural network (RNN), a long-short term model (LSTM), or another neural network. The learning model is not limited to the neural network, and may be another machine learning model.

The learning unit 111 performs machine learning using learning data collected from the Near-RT RIC 200 according to a collection scheme. The function of the learning unit 111 may be realized by executing an rApp for learning processing. The learning unit 111 performs necessary data processing in order to input the acquired learning data to the learning model. For example, in a case where the learning data is collected by the first collection scheme, the learning data acquired from the Near-RT RIC 200 and the EI data stored in the EI data storage unit 120 are combined. That is, the learning unit 111 includes a data synthesis unit that synthesizes learning data. The data synthesis processing includes shaping processing such as matching the generation time of each data. The learning unit 111 performs machine learning such as deep learning to generate a learned learning model. The learning unit 111 inputs learning data to the learning model of the model storage unit 112 and trains the learning model. For example, the learning data includes the EI data of the external server 400 and the RAN data of the O-DU and the O-CU, and the analysis and control according to the RAN data are learned by using these pieces of data. Furthermore, the learning model may be trained using the inference result by including the inference result inferred by the Near-RT RIC 200 in the learning data. The learning unit 111 stores the learned learning model in the model storage unit 112, further transmits the learned learning model to the Near-RT RIC 200, and applies the learned learning model to the inference model.

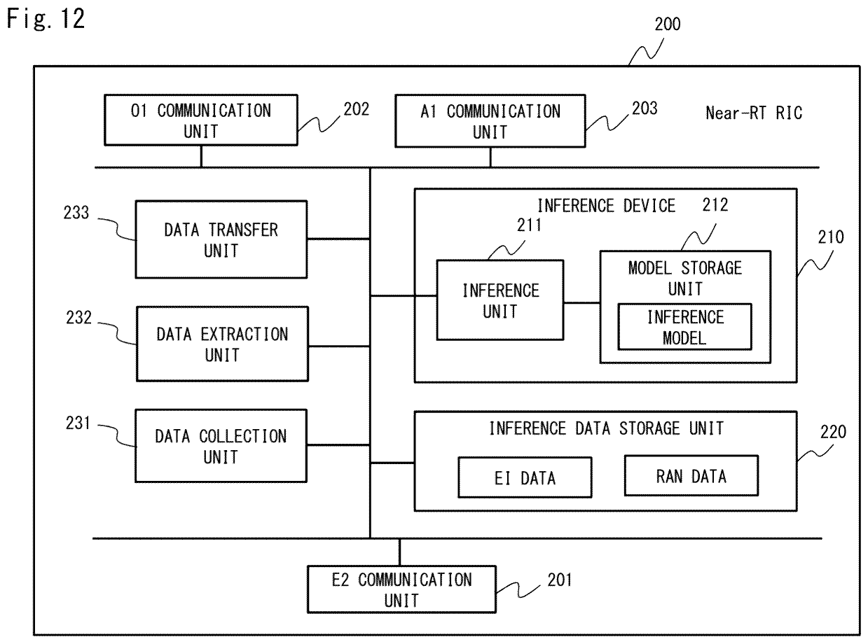

FIG. 12 illustrates a configuration example of the Near-RT RIC 200 according to the present example embodiment. As illustrated in FIG. 12, the Near-RT RIC 200 includes the inference device 210 and the inference data storage unit 220 described above. For example, the inference device 210 includes an inference unit 211 and a model storage unit 212. Further, the Near-RT RIC 200 includes an E2 communication unit 201, an O1 communication unit 202, an A1 communication unit 203, a data collection unit 231, a data extraction unit 232, and a data transfer unit 233. Note that the configuration is an example, and another configuration may be used as long as the operation according to the present example embodiment described below can be performed. In addition, a configuration for realizing a function necessary for the Near-RT RIC may be included.

The E2 communication unit 201 is a communication unit that communicates with the E2 node 300 via the E2 interface. For example, the E2 communication unit 201 transmits and receives various data including RAN data, control messages, and the like to and from the O-DU or the O-CU which is the E2 node 300 according to a communication scheme defined as the E2 interface.

The O1 communication unit 202 is a communication unit that communicates with the Non-RT RIC 100 via the O1 interface. For example, the O1 communication unit 202 transmits and receives various data including learning data, control messages, and the like to and from the Non-RT RIC 100 according to a communication scheme defined as the O1 interface.

The A1 communication unit 203 is a communication unit that communicates with the Non-RT RIC 100 via the A1 interface. For example, the A1 communication unit 203 transmits and receives various data including EI data, a control message including a control policy, and the like to and from the Non-RT RIC 100 according to a communication scheme defined as the A1 interface.

The data collection unit 231 collects data necessary for inference, control, and the like from the Non-RT RIC 100 and the E2 node 300. At the time of inference, the data collection unit 231 collects EI data from the external server 400 through the Non-RT RIC 100 via the A1 interface through the A1 communication unit 203. For example, the data collection unit 231 and the A1 communication unit 203 correspond to the collection unit 21 in FIG. 2. In addition, the data collection unit 231 collects the RAN data from the E2 node 300 via the E2 interface via the E2 communication unit 201. The data collection unit 231 periodically collects the EI data and the RAN data as inference data used for inference by the inference model of the inference device 210. The data collection unit 231 may instruct the Non-RT RIC 100 and the E2 node 300 on the data to be collected and the cycle. The data collection unit 231 outputs the collected EI data and RAN data to the inference unit 211 as inference data and stores the data in the inference data storage unit 220. For example, in the EI data acquired from the Non-RT RIC 100, a collection scheme is designated, and the EI data and the collection scheme are stored in association with each other in the inference data storage unit 220.

The data extraction unit 232 extracts data to be transferred as learning data from the inference data stored in the inference data storage unit 220. The data extraction unit 232 extracts data according to a collection scheme set in the stored EI data. As a result, data specified by the collection scheme determined by the Non-RT RIC 100 is extracted. That is, the data extraction unit 232 extracts data excluding the EI data designated in the first collection scheme as learning data. In other words, in a case where the EI data is the first collection scheme, the EI data is not extracted, and in a case where the EI data is the second collection scheme, the EI data is extracted. As a result, the El data and the RAN data designated in the second collection scheme are extracted as learning data. Note that the learning data to be transferred may include inference result data of the inference device 210.

The data transfer unit 233 transfers the extracted learning data to the Non-RT RIC 100 via the O1 interface through the O1 communication unit 202. For example, the data transfer unit 233 and the O1 communication unit 202 correspond to the transmission unit 22 in FIG. 2. The data transfer unit 233 transmits the learning data in accordance with an instruction from the Non-RT RIC 100. The learning data designated from the Non-RT RIC 100 may be transmitted at the designated timing. In addition, the learning data may be transmitted according to the communication status of the O1 interface.

The model storage unit 212 stores an inference model used by the inference unit 211 for inference processing. The inference model is a learned model and is a model that infers the control of the E2 node 300 according to the RAN data and the EI data. The inference model is the same model as the learning model of the Non-RT RIC 100, and is, for example, a model capable of analyzing and predicting time-series data.

The inference unit 211 analyzes the collected RAN data and EI data, and infers (specifies) the control of the E2 node based on the analysis result. The function of the inference unit 211 may be realized by executing xApp for inference processing. The inference unit 211 analyzes the data and specifies the control content (control information) using the inference model stored in the model storage unit 212. The inference unit 211 inputs the collected RAN data and EI data to the inference model, and specifies the control content of the E2 node 300 according to the RAN data and the EI data. Furthermore, a plurality of control contents may be inferred (predicted), and the control contents to be used for control may be specified according to the control policy. The inference unit 211 outputs a specification result that specifies the control content, that is, an inference result, as the control information. For example, the future radio quality around the UE is predicted from the radio quality and weather information, the radio intensity, the modulation scheme, and the like to be set in the E2 node 300 are specified according to the predicted radio quality, and control information to be set in the corresponding E2 node 300 is output. The inference unit 211 transmits control information indicating the specified control content to the O-DU or the O-CU of the E2 node 300 via the E2 interface through the E2 communication unit 201. Furthermore, the inference unit 211 may store the inference result (control information) in the inference data storage unit 220.

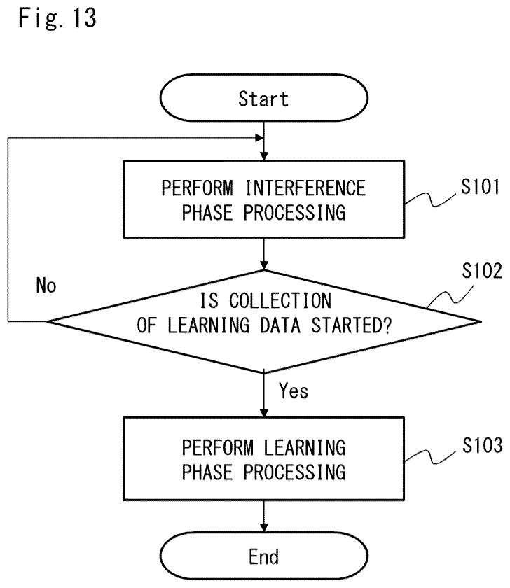

FIG. 13 illustrates an outline of an operation in the RAN system 1 according to the present example embodiment. Note that, in this example, the learning phase processing is performed subsequent to the inference phase processing, but the inference phase processing and the learning phase processing may be executed in parallel.

As illustrated in FIG. 13, the RAN system I executes inference phase processing (S101). The Near-RT RIC 200 collects inference data from the Non-RT RIC 100 and the E2 node 300 and infers control of the RAN using the collected inference data. The Near-RT RIC 200 controls the E2 node 300 based on the inference result. The Near-RT RIC 200 repeatedly performs collection and inference of inference data. In addition, the Near-RT RIC 200 accumulates inference data used for inference. Note that the Near-RT RIC 200 may start accumulating the inference data in a case where an instruction is given from the Non-RT RIC 100.

Next, the RAN system 1 determines whether to start the collection of the learning data (S102), and executes learning phase processing in a case where starting the collection of the learning data (S103). For example, in a case where learning of the learning model is required, accumulation of inference data used as learning data may be started, and in a case where accumulation of inference data necessary for learning is completed, collection of learning data may be started. For example, the Non-RT RIC 100 may determine that learning of the learning model is necessary in a case where an instruction is input from an operator or an external apparatus, in a case where the environment of the site including the UE changes, in a periodic timing, in a case where the accuracy of the inference model decreases, or the like. The change in environment may be detected from a change in radio quality, or a signal indicating a change in environment such as a layout change may be input. The accuracy of the inference model may be determined from the inference result of the inference model, the RAN data, and the like.

In a case where inference data of a predetermined data amount or a data amount instructed by the Non-RT RIC 100 is accumulated in the Near-RT RIC 200, the Non-RT RIC 100 determines to start collection of learning data. In a case where the predetermined accumulation period or the accumulation period instructed by the Non-RT RIC 100 ends, it may be determined to start the collection of the learning data. For example, in a case where the Near-RT RIC 200 notifies the Non-RT RIC 100 that the accumulation of the inference data has been completed, the Non-RT RIC 100 starts to collect the learning data and trains the learning model using the collected learning data. For example, learning data for one hour may be collected and used for training. The learned learning model generated by learning is applied to the Near-RT RIC 200 as the inference model. In a case where learning of the learning model is necessary, the Non-RT RIC 100 repeatedly executes collection of learning data and learning of the learning model in S102 and S103.

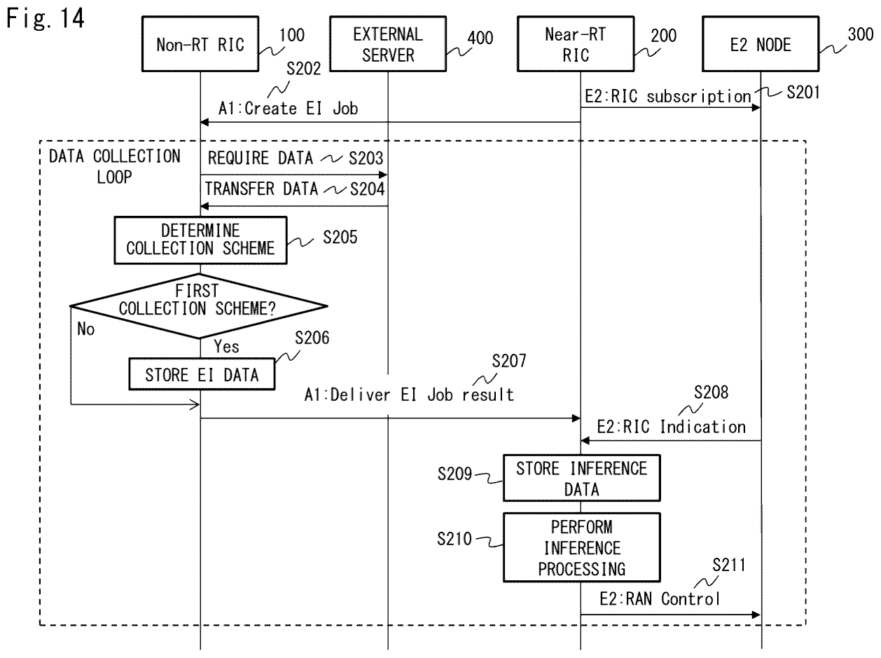

FIG. 14 is a sequence diagram illustrating an operation example of the inference phase processing (S101) of FIG. 13. FIG. 14 illustrates an example in which the collection scheme is determined every time the Non-RT RIC 100 repeatedly acquires the external data from the external server 400. Note that FIG. 14 is an example, and some processes may be executed in a changed order, or some processes may be executed in parallel. For example, S202 may be executed after S201, or S201 and S202 may be executed in parallel. After S208, S203 to S207 may be executed, or S203 to S207 and S208 may be executed in parallel.

As illustrated in FIG. 14, the Near-RT RIC 200 transmits a RIC subscription message to the E2 node 300 via the E2 interface, and requests RAN data for inference (S201). For example, the data collection unit 231 requests transfer of RAN data in order to collect RAN data used for inference. The RIC subscription message is a message defined in the E2 interface, and is a message requesting periodic transfer of RAN data. The data collection unit 231 designates information for identifying data to be transferred and a timing to transfer the data, for example, in a RIC subscription message. The information for identifying the designated data may indicate an ID or a name of the data, or may include a size of the data. In the case of data for each UE or data with a base station (cell), information for identifying the UE or the base station may be designated. The designated timing may include a transfer cycle or interval, a transfer time, the number of transfers, and a transfer period. A plurality of pieces of RAN data may be requested in the RIC subscription message. The RIC subscription message may include information identifying a data transfer source. The information for identifying the data transfer source may be information for identifying the O-DU or an O-CU. Thereafter, the E2 node 300 repeatedly transfers the RAN data at a timing designated by the RIC subscription message (S208).

Next, the Near-RT RIC 200 transmits a Create EI Job message to the Non-RT RIC 100 via the A1 interface, and requests EI data for inference (S202). For example, the data collection unit 231 requests transfer of the EI data in order to collect the EI data used for inference. The Create EI Job message is a message defined by the A1 interface and is a message requesting periodic transfer of the EI data. The data collection unit 231 designates, for example, information for identifying a data providing source, information for identifying data to be transferred, and a timing of transferring the data in a Create EI Job message. The information for identifying the data providing source may be a URL, an IP address, or the like for identifying the external server 400. The information for identifying the data may indicate an ID or a name of the data or may include a size of the data. The timing may include a transfer cycle or interval, a transfer time, the number of transfers, and a transfer period. A plurality of pieces of EI data may be requested in the Create EI Job message. Thereafter, the Non-RT RIC 100 repeatedly acquires and transfers the EI data at the timing designated by the Create EI Job message (S203 to S207). Note that the EI data may be requested and transferred between the Near-RT RIC 200 and the Non-RT RIC 100 via the O1 interface.

Next, upon receiving the Create EI Job message from the Near-RT RIC 200, the Non-RT RIC 100 requests the external server 400 for EI data for inference via the interface with the external server 400 (S203). For example, the data collection unit 131 requests the external server 400 for data specified in the Create EI Job message at the time receiving the Create EI Job message or at a timing specified in the Create EI Job message. The data collection unit 131 transmits a data request message usable in an interface with the external server 400. The data request message may be, for example, an HTTP Get request message. The data collection unit 131 may designate information for identifying a data providing source or information for identifying data to be transferred in the data request message. For example, the information for identifying the data providing source and the information for identifying the data may be information specified in the Create EI Job message. That is, the information for identifying the data providing source may be a URL, an IP address, or the like for identifying the external server 400. The information for identifying the data may indicate an ID or a name of the data or may include a size of the data. A plurality of pieces of data may be requested in the data request message. Note that the timing to transfer data may be designated in the data request message, and the external server 400 may periodically transmit data at the designated timing.

Next, upon receiving the EI data request for inference from the Non-RT RIC 100, the external server 400 transfers the requested EI data to the Non-RT RIC 100 via the interface with the Non-RT RIC 100 (S204). Upon receiving the data request message, the external server 400 transmits the EI data designated by the received data request message to the Non-RT RIC 100. The external server 400 transmits a data transfer message that can be used in an interface with the Non-RT RIC 100. The data transfer message may be, for example, an HTTP Get response message. According to the data request message, the plurality of pieces of data may be transferred in the data transfer message.

Next, upon receiving the EI data from the external server 400, the Non-RT RIC 100 determines the collection scheme (S205). For example, the scheme determination unit 132 determines the collection scheme based on the feature of data such as a data size, the number of parameters, and a sampling cycle of the acquired EI data. For example, the scheme determination unit 132 may extract a data size from the acquired EI data, select the first collection scheme in a case where the extracted data size is larger than a predetermined threshold value, and select the second collection scheme in a case where the data size is smaller than the predetermined threshold value. In addition, the scheme determination unit 132 may extract the number of parameters from the acquired EI data, select the second collection scheme in a case where the extracted number of parameters is larger than a predetermined threshold value, and select the first collection scheme in a case where the number of parameters is smaller than the predetermined threshold value. Further, the scheme determination unit 132 may extract the data size from the acquired EI data, select the first collection scheme in a case where the data amount calculated from the data size and the sampling cycle is larger than a predetermined threshold value with the collection cycle instructed from the Near-RT RIC as the sampling cycle, and select the second collection scheme in a case where the calculated data amount is smaller than the predetermined threshold value. In a case where a plurality of pieces of EI data is acquired, the collection scheme may be determined for each piece of EI data based on the feature of the data, or the collection scheme may be determined for each piece of the plurality of pieces of EI data based on the feature of the entire data including the plurality of pieces of EI data.

Next, in a case where the determined collection scheme is the first collection scheme, the Non-RT RIC 100 stores the acquired EI data in the EI data storage unit 120 (S206). For example, if the EI data is transferred, the data transfer unit 133 determines the collection scheme, stores the acquired EI data in the EI data storage unit 120 in a case where the first collection scheme is selected, and does not store the acquired EI data in the EI data storage unit 120 in a case where the second collection scheme is selected.

Next, the Non-RT RIC 100 transmits a Deliver EI Job result message to the Near-RT RIC 200 via the A1 interface, and transfers the EI data for inference (S207). For example, the data transfer unit 133 transfers the EI data according to an instruction of the Create EI Job message. The Deliver EI Job result message is a message defined by the A1 interface and is a message for transferring the EI data. The data transfer unit 133 repeatedly transmits the data designated by the Create EI Job message at the timing designated by the Create EI Job message. The plurality of pieces of EI data may be transferred in the Deliver EI Job result message according to the Create EI Job message. In addition, the data transfer unit 133 designates the collection scheme determined by the scheme determination unit 132 in the Deliver EI Job result message together with the EI data for inference. In other words, it is designated whether the data is data to be extracted as learning data or whether the data is data to be reduced in weight in a case where the learning data is transferred. For example, in the Deliver EI Job result message, a flag indicating the first collection scheme or the second collection scheme or a flag indicating whether to extract data for learning is designated. Note that the collection scheme may be notified by a message different from the Deliver EI Job result message.

Further, once receiving the RIC subscription message from the Near-RT RIC 200, the E2 node 300 transmits the RIC Indication message to the Near-RT RIC 200 via the E2 interface according to the designation of the RIC subscription message, and transfers the RAN data for inference (S208). The RIC Indication message is a message defined by the E2 interface and is a message for transferring the RAN data. In a case where the transfer source of the data is designated in the RIC subscription message, the designated E2 node 300 transmits the RIC subscription message. The E2 node 300 repeatedly transmits the data designated in the RIC subscription message at the timing designated in the RIC subscription message. The plurality of pieces of RAN data may be forwarded in the RIC Indication message according to the RIC subscription message.

Next, once acquiring the EI data from the Non-RT RIC 100 and acquiring the RAN data from the E2 node 300, the Near-RT RIC 200 stores the acquired EI data and RAN data as inference data in the inference data storage unit 220 (S209). For example, the data collection unit 231 stores the EI data acquired from the Non-RT RIC 100 and the flag designating the collection scheme in the inference data storage unit 220 in association with each other, and stores the RAN data acquired from the E2 node 300 in the inference data storage unit 220. Note that, if the EI data is stored, only the data for which the second collection scheme is designated may be stored in the inference data storage unit 220, and if the learning data is transferred, all pieces of data stored in the inference data storage unit 220 may be used as the learning data.

Next, the Near-RT RIC 200 performs inference processing using the acquired EI data and RAN data as inference data (S210). For example, the inference unit 211 inputs the acquired EI data and RAN data to the learning model and infers the control of the RAN according to the EI data and the RAN data.

Next, based on the inference result, the Near-RT RIC 200 transmits a RAN Control message to the E2 node 300 via the E2 interface, and sets a radio control parameter (S211). For example, the inference unit 211 generates the radio control parameter for controlling the E2 node 300 based on the inference result of the inference model, and transmits the generated radio control parameter. The RAN Control message is a message defined by the E2 interface and is a message for controlling the E2 node. The inference unit 211 may specify information for identifying the E2 node 300, information for identifying the radio control parameter, a value of the radio control parameter, and the like in the RAN Control message. The information for identifying the E2 node 300 may be information for identifying the O-DU or O-CU. The information for identifying the radio control parameter may indicate an ID or a name of the parameter. A plurality of radio control parameters may be set in the RAN Control message.

For example, the Near-RT RIC 200 stores inference data and performs inference processing every time the EI data and the RAN data are received. Note that the inference processing may be performed using the received EI data and the previously received RAN data if the EI data is received, or the inference processing may be performed using the received RAN data and the previously received EI data if the RAN data is received. In addition, the unit of performing the inference processing is not limited to one piece of EI data and one piece of RAN data. The inference processing may be performed using one or more arbitrary numbers of EI data and one or more arbitrary numbers of RAN data. In a case where the reception of the predetermined number of EI data is completed and the reception of the predetermined number of RAN data is completed, the inference processing may be performed using the predetermined number of EI data and the predetermined number of RAN data. For example, the inference processing may be performed using a plurality of pieces of EI data acquired from a plurality of external servers 400 and a plurality of pieces of RAN data acquired from a plurality of E2 nodes 300 including the O-DU and an O-CU.

Further, once receiving the RAN Control message, the E2 node 300 sets the radio control parameter according to the designation of the RAN Control message. The E2 node 300 may transmit the setting result of the radio control parameter to the Near-RT RIC 200. In a case where the setting of the radio control parameter fails, the Near-RT RIC 200 may set the same radio control parameter to the E2 node 300 again or may perform the inference processing again. The Near-RT RIC 200 may store the received setting result in the inference data storage unit 220 together with the inference result.

After S201 and S202, the data collection loop of S203 to S211 is repeated. In the example of FIG. 14, the collection scheme is determined every time EI data is acquired from the external server 400 in the data collection loop. That is, the collection scheme is determined according to a change in data acquired a plurality of times. As a result, the collection scheme can be switched for each data acquired from the external server 400. For example, among data repeatedly collected, some data may be stored in the Non-RT RIC 100 as the first collection scheme, and other data may be collected from the Near-RT RIC 200 as the second collection scheme.

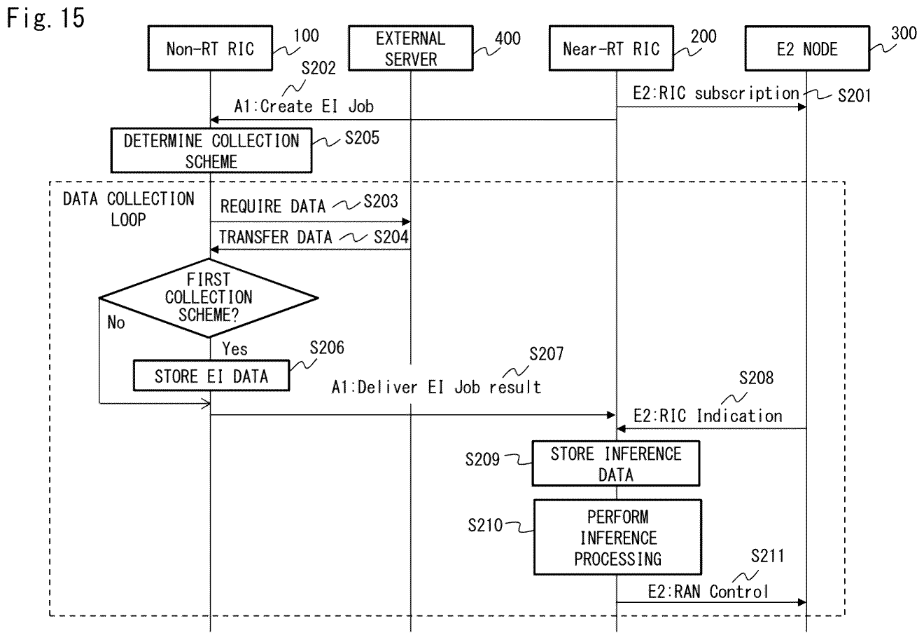

FIG. 15 is a sequence diagram illustrating another operation example of the inference phase processing (S101) of FIG. 13. FIG. 15 illustrates an example in which the Non-RT RIC 100 determines the collection scheme before repeatedly acquiring the external data from the external server 400. As described above, if it is known in advance that there is no large variation in the features of the data transferred from the external server, the collection scheme may not be determined every time the EI data for inference is transferred to the Near-RT RIC.

In the example of FIG. 15, the timing of determination of the collection scheme (S205) is different from that in FIG. 14, and other processing is similar to that in FIG. 14. That is, in the example of FIG. 15, once the Non-RT RIC 100 receives the Create EI Job message from the Near-RT RIC 200 in S202, the collection scheme is determined in S205. For example, the collection scheme is determined at a timing a request for EI data is received from the Near-RT RIC 200. For example, in a case where the feature of the EI data to be acquired is set in advance, the scheme determination unit 132 determines the collection scheme based on the set information. For example, the data size and the number of parameters may be set in association with each piece of EI data, and the collection scheme may be determined using the data size and the number of parameters corresponding to the data designated in the Create EI Job message. Note that the collection scheme may be determined based on other information designated in the Create EI Job message. For example, the collection scheme may be determined based on information for identifying a designated data providing source, that is, the external server 400. The identification information of the external server 400 and the collection scheme may be set in association with each other, and the collection scheme may be determined by the collection scheme corresponding to the identification information of the data providing source designated in the Create EI Job message.

In addition, it may be selected whether the collection scheme is determined at the timing of FIG. 15 or the collection scheme is determined at the timing of FIG. 14. For example, the Near-RT RIC 200 may designate the collection scheme determination timing in a Create EI Job message. The Non-RT RIC 100 may select the collection scheme determination timing according to the data designated in the Create EI Job message. In a case where the data having no variation in the feature of the data and the data having variation in the feature of the data are classified in advance, and the data having no variation in the feature of the data is collected, the collection scheme may be determined at the timing of FIG. 15, and in a case where the data having variation in the feature of the data is collected, the collection scheme may be determined at the timing of FIG. 14.

In the example of FIG. 15, after the collection scheme is determined, the data collection loop is repeatedly executed as in FIG. 14 (S203 and S204, S206 to S211). In the data collection loop, the Non-RT RIC 100 acquires EI data from the external server 400 and stores the EI data according to a predetermined collection scheme. Note that, since the collection scheme does not change in the data collection loop, it is not necessary to notify the collection scheme every time the EI data is transferred from the Non-RT RIC 100 to the Near-RT RIC 200 in S207. For example, the collection scheme may be notified by a Deliver EI Job result message transmitted first after the Create EI Job message, and the notification of the collection scheme may be omitted by the subsequent Deliver EI Job result message. For example, the collection scheme may be notified in a case where the collection scheme is changed from the previous notification.

Note that the collection scheme may be determined at another timing. The collection scheme may be determined before S201, that is, before the inference phase processing. In a case where the EI data to be collected is determined in advance, the collection scheme may be determined based on the feature of the EI data scheduled to be collected. In addition, the collection scheme may be determined at an arbitrary timing according to an instruction from an operator or a load of the RAN system 1.

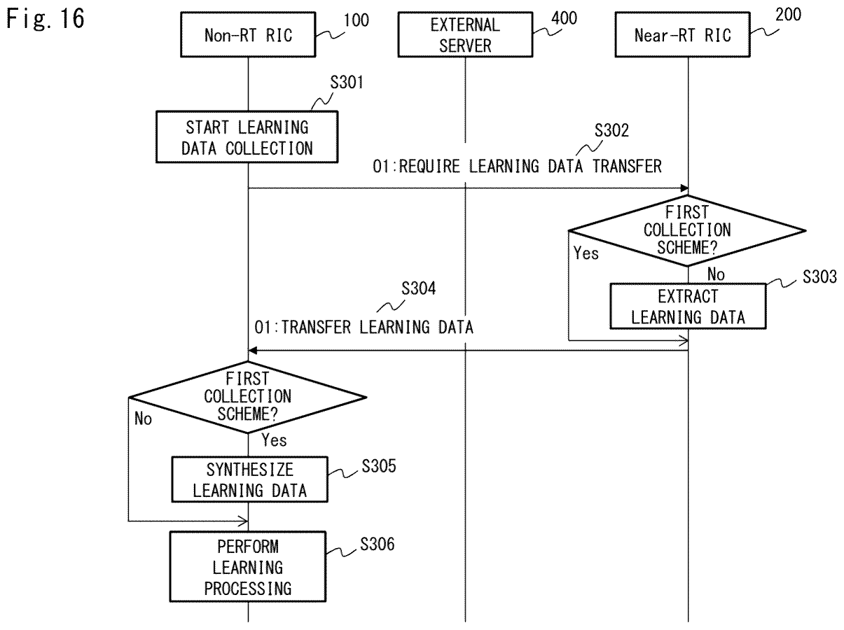

FIG. 16 is a sequence diagram illustrating an operation example of the learning phase processing (S103) of FIG. 13. After the inference data is collected and stored in the inference phase processing of FIGS. 14 and 15, the processing of FIG. 16 is executed.

As illustrated in FIG. 16, once starting to collect the learning data (S301), the Non-RT RIC 100 requests transfer of the learning data via the O1 interface (S302). For example, in a case where it is determined that the collection of the learning data is necessary, the learning unit 111 requests transfer of the learning data. In a case where the Near-RT RIC 200 stores a predetermined amount of inference data, the Near-RT RIC 200 may notify the Non-RT RIC 100 of the completion of the storage, and the Non-RT RIC may determine to start the collection of the learning data and transmit the transfer request of the learning data in a case where the storage completion notification is received. The learning unit 111 may transmit the transfer request of the learning data using an arbitrary message defined by the O1 interface. The transfer timing or the like may be designated in the transfer request of the learning data. Note that the learning data may be requested and transferred between the Non-RT RIC 100 and the Near-RT RIC 200 via the A1 interface.

Next, once receiving the transfer request of the learning data from the Non-RT RIC 100, the Near-RT RIC 200 extracts the learning data from the inference data storage unit 220 according to the collection scheme (S303). The data extraction unit 232 determines a collection scheme set for the inference data for each piece of the inference data stored in the inference data storage unit 220, and extracts the collection scheme as the learning data according to the determined collection scheme. The data extraction unit 232 extracts the inference data of the second collection scheme without extracting the inference data of the first collection scheme, and generates the learning data to be transferred. For example, the EI data and the RAN data of the remaining second collection scheme are extracted as the learning data except for the EI data for which the first collection scheme is designated. As a result, learning data that is reduced in weight except for the EI data held by the Non-RT RIC 100 is generated.

Next, the Near-RT RIC 200 transfers the extracted learning data to the Non-RT RIC 100 via the O1 interface (S304). For example, once the learning data is extracted from the inference data of the inference data storage unit 220, the data transfer unit 233 transfers the learning data reduced in weight according to the collection scheme. The data transfer unit 233 may transfer the learning data using an arbitrary message defined by the O1 interface. In a case where the transfer timing is designated by the transfer request of the learning data, the learning data may be transmitted at the designated timing. In a case where the transmission band of the O1 interface is free, the learning data may be transmitted.

Next, upon receiving the learning data from the Near-RT RIC 200, the Non-RT RIC 100 synthesizes the EI data stored in the EI data storage unit 120 with the received learning data according to the collection scheme (S305). For example, the learning unit 111 may determine whether the EI data is stored in the EI data storage unit 120 as the determination of the collection scheme. In a case where the EI data is stored in the EI data storage unit 120, the learning unit 111 determines that a first collection scheme or the data of the first collection scheme is included, combines the EI data stored in the EI data storage unit 120 and the learning data received via the O1 interface, and shapes the combined data into data necessary for input to the learning model. In a case where the EI data is not stored in the EI data storage unit 120, it is determined that there is no data corresponding to a second collection scheme or the first collection scheme, and the synthesis of the learning data is not performed.

Furthermore, the learning unit 111 may determine the collection scheme set for each EI data. The EI data collection scheme may be held at the time the scheme determination unit 132 determines the collection scheme. In a case where there is the EI data set to the first collection scheme, the learning unit 111 acquires the corresponding EI data from the EI data storage unit 120, and combines the acquired EI data with the learning data received via the O1 interface. In a case where there is no EI data set in the first collection scheme, synthesis of learning data is not performed.

Next, the Non-RT RIC 100 performs learning processing using the learning data synthesized according to the collection scheme (S306). For example, in a case where the EI data is stored in the EI data storage unit 120, that is, in the case of the first collection scheme, the learning unit 111 trains the learning model using composite data obtained by combining the EI data stored in the EI data storage unit 120 and the learning data received from the Near-RT RIC 200. Furthermore, in a case where the EI data is not stored in the EI data storage unit 120, that is, in the case of the second collection scheme, the learning unit 111 trains the learning model using the learning data received from the Near-RT RIC 200. Upon completion of learning, the learning unit 111 stores the learned learning model in the model storage unit 112 and transmits the learned learning model to the Near-RT RIC 200. The Near-RT RIC 200 applies the received learned learning model to the inference model and performs inference processing with the updated inference model.

As described above, in the present example embodiment, the Non-RT RIC collects the EI data for inference from the external server, and the collection scheme in which the Non-RT RIC collects the learning data is selected according to the feature or the like of the collected EI data. The first collection scheme is selected, the data collected by the Non-RT RIC for inference is held, and the reduced learning data is transferred from the Near-RT RIC to the Non-RT RIC, whereby the network load of the O1 interface that transfers the learning data can be suppressed. In addition, by selecting the second collection scheme and transferring all the data necessary for learning from the Near-RT RIC to the Non-RT RIC, it is possible to reduce the load of the shaping processing of the learning data in the Non-RT RIC. Therefore, since the load of the O1 interface or the load of the processing of the Non-RT RIC can be reduced according to the feature of the data collected for inference and used for learning, the collection processing of the learning data can be made efficient, and the learning data can be efficiently generated.

### Second Example Embodiment

Next, a second example embodiment will be described. In the present example embodiment, an example in which the collection scheme is fixed to the first collection scheme and the learning data is collected will be described. Note that the present example embodiment can be implemented in combination with the first example embodiment, and may be implemented by appropriately using the configuration of the first example embodiment. For example, since the configuration of the present example embodiment is similar to that of the first example embodiment, the description thereof is omitted. In the present example embodiment, the scheme determination unit 132 in the Non-RT RIC 100 of FIG. 10 may be omitted.

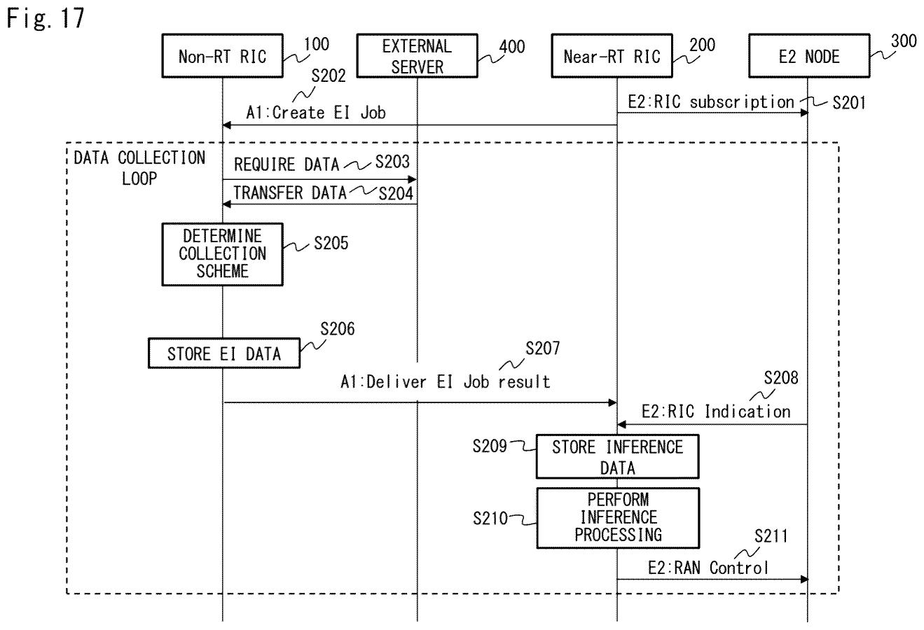

FIG. 17 illustrates an operation example of the inference phase processing (S101) in the present example embodiment. In the present example embodiment, since it is sufficient that at least the first collection scheme can be performed, the Non-RT RIC 100 does not determine the collection scheme (S205) as compared with the first example embodiment. In addition, in S206, the EI data acquired from the external server 400 is stored without determining the collection scheme. Further, in a case where the EI data is transferred from the Non-RT RIC 100 to the Near-RT RIC 200 in S207, it is not necessary to notify the collection scheme. The rest is the same as in the first example embodiment. If the inference data is stored in S209, the EI data collected from the Non-RT RIC 100 may not be stored in the inference data storage unit 220, and if the learning data is transferred, the RAN data stored in the inference data storage unit 220 may be transferred as the learning data.

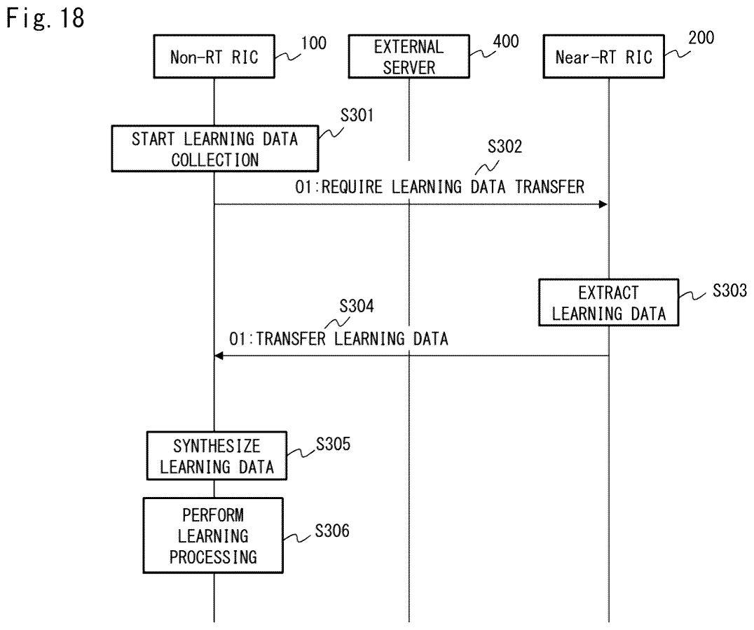

FIG. 18 illustrates an operation example of the learning phase processing (S103) in the present example embodiment. In the present example embodiment, since it is sufficient that at least the first collection scheme can be performed, the Near-RT RIC 200 extracts the learning data in S303 without determining the collection scheme, as compared with the first example embodiment. That is, the learning data is generated by extracting only the RAN data collected from the E2 node 300 except the EI data collected via the Non-RT RIC 100 from the data stored in the inference data storage unit 220. In addition, in S305, the Non-RT RIC 100 synthesizes the learning data without determining the collection scheme. That is, the EI data stored in the EI data storage unit 120 and the learning data collected via the O1 interface are combined. The rest is the same as in the first example embodiment.

As described above, the data collected by the Non-RT RIC for inference is held by the first collection scheme, and the reduced learning data is transferred from the Near-RT RIC to the Non-RT RIC, whereby the network load of the O1 interface that transfers the learning data can be suppressed.

### Third Example Embodiment

Next, a third example embodiment will be described. In the present example embodiment, an example in which the collection scheme is fixed to the second collection scheme and the learning data is collected will be described. Note that the present example embodiment can be implemented in combination with any one of the first and second example embodiments, and may be implemented by appropriately using the configuration of any one of the first and second example embodiments. For example, since the configuration of the present example embodiment is similar to that of the first example embodiment, the description thereof is omitted. In the present example embodiment, the scheme determination unit 132 and the EI data storage unit 120 in the Non-RT RIC 100 of FIG. 10 may be omitted.

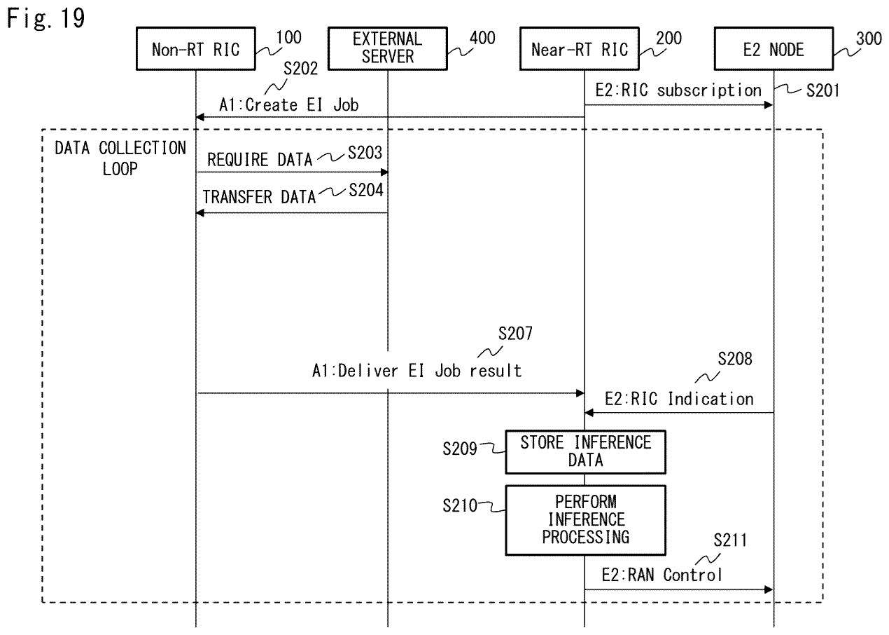

FIG. 19 illustrates an operation example of the inference phase processing (S101) in the present example embodiment. In the present example embodiment, since it is sufficient that at least the second collection scheme can be performed, the Non-RT RIC 100 does not determine the collection scheme (S205) and does not store the EI data (S206) as compared with the first example embodiment. That is, once the Non-RT RIC 100 acquires the EI data from the external server 400 in S204, the Non-RT RIC 100 transfers the EI data for inference to the Near-RT RIC 200 in S207. Further, in a case where the EI data is transferred from the Non-RT RIC 100 to the Near-RT RIC 200 in S207, it is not necessary to notify the collection scheme. The rest is the same as in the first example embodiment.

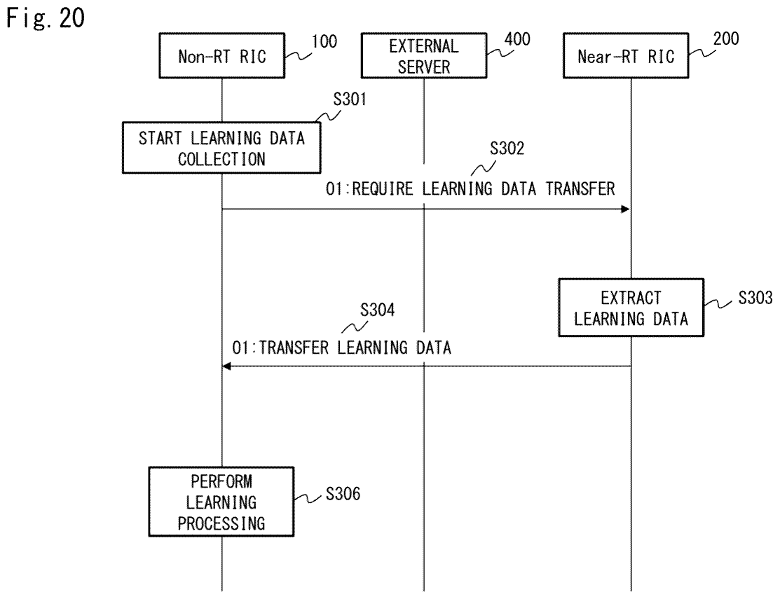

FIG. 20 illustrates an operation example of the learning phase processing (S103) in the present example embodiment. In the present example embodiment, since it is sufficient that at least the second collection scheme can be performed, the Near-RT RIC 200 extracts the learning data without determining the collection scheme in S303, as compared with the first example embodiment. That is, all the data including the EI data and the RAN data stored in the inference data storage unit 220 is extracted to generate the learning data. In addition, the Non-RT RIC 100 does not combine the learning data (S305). That is, in S306, the Non-RT RIC 100 performs learning processing using the learning data received from the Near-RT RIC 200. The rest is the same as in the first example embodiment.

In this way, by transferring all data necessary for learning from the Near-RT RIC to the Non-RT RIC by the second collection scheme, it is possible to reduce the load of the shaping processing of the learning data in the Non-RT RIC.

### Fourth Example Embodiment

Next, a fourth example embodiment will be described. In the present example embodiment, an example in which learning data is further collected by the third collection scheme will be described. Note that the present example embodiment can be implemented in combination with any of the first to third example embodiments, and may be implemented by appropriately using any of the configurations of the first to third example embodiments. For example, since the configuration of the present example embodiment is similar to that of the first example embodiment, the description thereof is omitted.

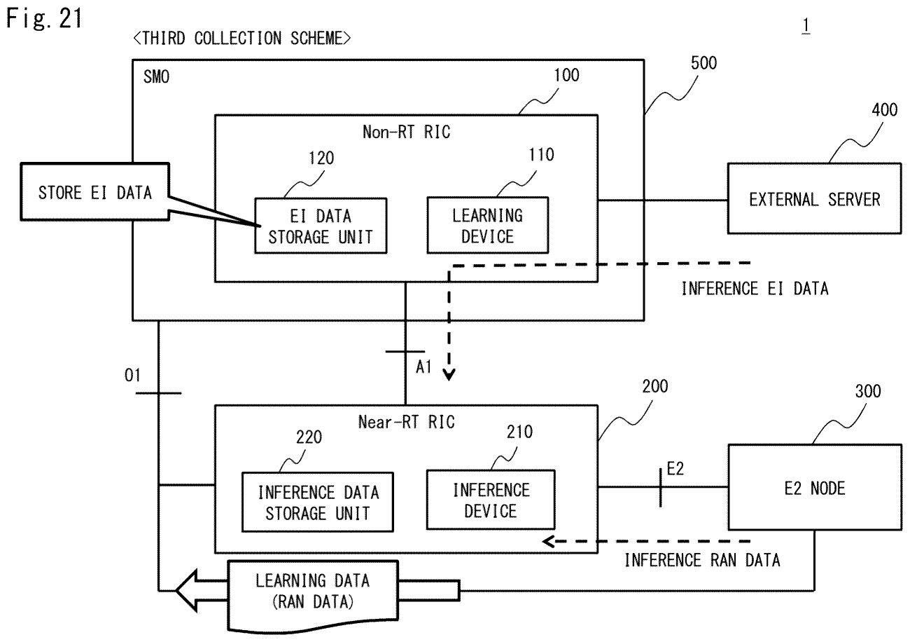

FIG. 21 illustrates a third collection scheme (collection scheme 3) of learning data according to the present example embodiment. As illustrated in FIG. 21, the third collection scheme is a method of transferring the learning data from the E2 node 300 to the Non-RT RIC 100. This can reduce the load on the Near-RT RIC 200.

In the third collection scheme, at the time of inference, the Non-RT RIC 100 acquires EI data for inference from the external server 400, stores the acquired EI data in the EI data storage unit 120, and transfers the EI data to the Near-RT RIC 200. The Near-RT RIC 200 performs inference by the inference device 210 using the EI data acquired from the Non-RT RIC 10 and the RAN data collected from the E2 node 300 as inference data.

In addition, in the third collection scheme, at the time of learning, the Non-RT RIC 100 collects the RAN data from the E2 node 300 via the O1 interface as learning data. The Non-RT RIC 100 combines the RAN data collected from the E2 node 300 and the EI data stored in the EI data storage unit 120, and performs learning using the combined learning data. Note that, similarly to the second collection scheme, the EI data used for inference may be transferred from the Near-RT RIC 200 to the Non-RT RIC 100 at the time of learning.

In this manner, the learning data may be transferred from the E2 node to the Non-RT RIC by the third collection scheme. One of the first to third collection schemes may be selected to collect the learning data. Similarly to the first example embodiment, the scheme determination unit 132 may select any one of the first to third collection schemes according to the feature of data, an instruction from an operator, and a load of the RAN system. Since the collection path of the learning data changes in the third collection scheme, it can be said that the scheme determination unit 132 selects the collection path of the learning data. For example, the third collection scheme may be selected according to the feature of the RAN data collected from the E2 node. In addition, the third collection scheme may be selected in a case where the load of the Near-RT RIC is large or in a case where there is a margin in the resources of the E2 node. As a result, the learning data can be collected by an appropriate method according to various situations.

### Fifth Example Embodiment

Next, a fifth example embodiment will be described. In the present example embodiment, an example in which an external server and a Near-RT RIC are directly connected will be described. Note that the present example embodiment can be implemented in combination with any of the first to fourth example embodiments, and may be implemented by appropriately using any of the configurations of the first to fourth example embodiments.

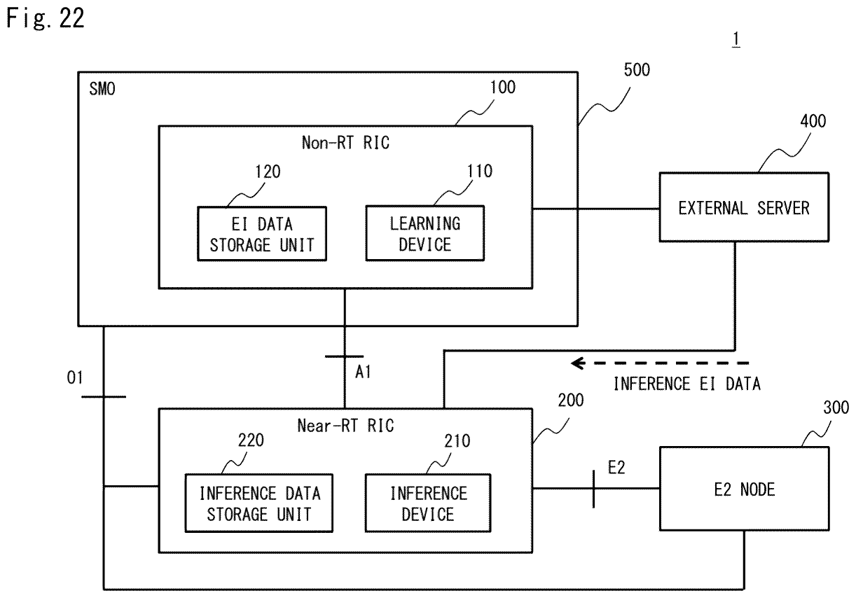

FIG. 22 illustrates a configuration example of the RAN system 1 according to the present example embodiment. As illustrated in FIG. 22, in the RAN system 1 according to the present example embodiment, the external server 400 and the Near-RT RIC 200 are directly connected as compared with the first example embodiment. The Near-RT RIC 200 may include an external communication unit similarly to the Non-RT RIC 100. Other configurations are, for example, similar to those of the first example embodiment.

The Near-RT RIC 200 and the external server 400 are communicably connected via an arbitrary interface similarly to the Non-RT RIC 100 and the external server 400. At the time of the inference, the Near-RT RIC 200 directly collects EI data for inference from the external server 400 via an interface with the external server 400. The Near-RT RIC 200 performs the inference using the EI data collected from the external server 400 and the RAN data collected from the E2 node 300. Note that, in this example, the transfer of the EI data for inference from the Non-RT RIC 100 to the Near-RT RIC 200 is unnecessary. For example, the Non-RT RIC 100 may acquire the EI data for inference from the external server 400 at an arbitrary timing.

In this manner, the Near-RT RIC may directly acquire the inference data from the external server. With such a configuration, the Near-RT RIC can control the RAN in more real time. For example, followability to a rapid state change of the radio environment is improved.

Note that the present disclosure is not limited to the above-described example embodiments, and can be appropriately modified without departing from the scope.

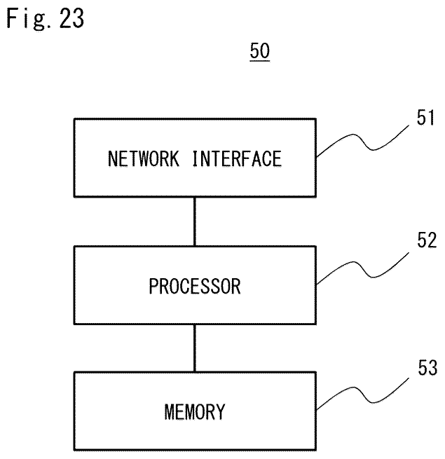

Each configuration in the above-described example embodiments may be implemented by hardware, software, or both, and may be implemented by one piece of hardware or software or by a plurality of pieces of hardware or software. Each apparatus and each function (processing) including the Non-RT RIC or the Near-RT RIC may be realized by a computer 50 including a network interface 51, a processor 52 such as a central processing unit (CPU), and a memory 53 which is a storage device as illustrated in FIG. 23. The network interface 51 may include a network interface card (NIC) for communicating with apparatuses including network nodes. For example, a program for performing the method in the example embodiment may be stored in the memory 53, and each function may be realized by executing the program stored in the memory 53 by the processor 52.

These programs include a group of commands (or software codes) causing a computer to perform one or more of the functions described in the example embodiments in a case of being read by the computer. The program may be stored in a non-transitory computer readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer readable medium or a communication medium. By way of example, and not limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A system including:
an acquisition means for acquiring data provided from a data providing apparatus as inference data for another system to perform inference by an inference model: and
a specifying means for specifying, from among data including the acquired inference data, data collected from the other system that has performed inference by the inference model, as learning data for a learning model for constructing the inference model.

### Supplementary Note 2

The system according to Supplementary Note 1, further including a transfer means for transferring inference data acquired from the data providing apparatus to the other system,
in which the specifying means specifies whether the inference data transferred to the other system is collected from the other system.

### Supplementary Note 3

The system according to Supplementary Note 2, further including a storage means for storing the inference data transferred to the other system,
in which the specifying means specifies whether the stored inference data is collected from the other system.

### Supplementary Note 4

The system according to Supplementary Note 3, further including a synthesis means for synthesizing inference data stored in the storage means and data collected from the other system to generate learning data to be input to the learning model in a case where the inference data is not collected from the other system.

### Supplementary Note 5

The system according to any one of Supplementary Notes 1 to 4, in which the specifying means specifies a route for collecting the learning data.

### Supplementary Note 6

The system according to any one of Supplementary Notes 1 to 5, in which the specifying means specifies data to be collected from the other system based on a feature of the inference data acquired from the data providing apparatus.

### Supplementary Note 7

The system according to Supplementary Note 6, in which the feature of the inference data includes a data size, the number of parameters, or a data acquisition cycle.

### Supplementary Note 8

The system according to Supplementary Note 6 or 7, in which the acquisition means acquires inference data from the data providing apparatus a plurality of times, and specifies data collected from the other system according to a change in the inference data acquired the plurality of times.

### Supplementary Note 9

The system according to any one of Supplementary Notes 1 to 8, in which the specifying means specifies data to be collected from the other system based on an input instruction.

### Supplementary Note 10

The system according to any one of Supplementary Notes 1 to 9, in which the specifying means specifies data to be collected from the other system based on a load of a system including the system and the other system.

### Supplementary Note 11

The system according to any one of Supplementary Notes 1 to 10, in which the data providing apparatus is a server outside a system including the system and the other system.

### Supplementary Note 12

The system according to any one of Supplementary Notes 1 to 11, in which
the inference model infers control related to a radio network according to the inference data, and
the learning model learns control related to the radio network according to the learning data.

### (upplementary Note 13

The system according to any one of Supplementary Notes 1 to 12, in which the system and the other system include a radio access network (RAN) intelligent controller (RIC) that controls a RAN.

### Supplementary Note 14

The system according to Supplementary Note 13, in which
the system includes a Non-RT (real time) RIC, and
the other system includes a Near-RT RIC.

### Supplementary Note 15

A system including:
a collection means for collecting data provided from a data providing apparatus as inference data for performing inference by an inference model; and
a transmission means for transmitting, as learning data for a learning model for constructing the inference model, data specified from among data including the collected inference data to another system that performs learning by the learning model.

### Supplementary Note 16

The system according to Supplementary Note 15, in which
the collection means collects the inference data via the other system, and
the specified data is data specified by the other system.

### Supplementary Note 17

An apparatus including:
an acquisition means for acquiring data provided from a data providing apparatus as inference data for another system to perform inference by an inference model; and
a specifying means for specifying, from among data including the acquired inference data, data collected from the other system that has performed inference by the inference model, as learning data for a learning model for constructing the inference model.

### Supplementary Note 18

An apparatus including:
a collection means for collecting data provided from a data providing apparatus as inference data for performing inference by an inference model: and
a transmission means for transmitting, as learning data for a learning model for constructing the inference model, data specified from among data including the collected inference data to another system that performs learning by the learning model.

### Supplementary Note 19

A method including:
acquiring data provided from a data providing apparatus as inference data for another system to perform inference by an inference model; and
specifying, from among data including the acquired inference data, data collected from the other system that has performed inference by the inference model, as learning data for a learning model for constructing the inference model.

### Supplementary Note 20

A method including:
collecting data provided from a data providing apparatus as inference data for performing inference by an inference model; and
transmitting, as learning data for a learning model for constructing the inference model, data specified from among data including the collected inference data to another system that performs learning by the learning model.

### Supplementary Note 21

A non-transitory computer readable medium storing a program for causing a computer to execute:
acquiring data provided from a data providing apparatus as inference data for another system to perform inference by an inference model; and
specifying, from among data including the acquired inference data, data collected from the other system that has performed inference by the inference model, as learning data for a learning model for constructing the inference model.

### Supplementary Note 22

A non-transitory computer readable medium storing a program for causing a computer to execute:
collecting data provided from a data providing apparatus as inference data for performing inference by an inference model; and
transmitting, as learning data for a learning model for constructing the inference model, data specified from among data including the collected inference data to another system that performs learning by the learning model.

### REFERENCE SIGNS LIST

1 RAN SYSTEM
10 FIRST SYSTEM
11 ACQUISITION UNIT
12 SPECIFYING UNIT
20 SECOND SYSTEM
21 COLLECTION UNIT
22 TRANSMISSION UNIT
30 FIRST APPARATUS
40 SECOND APPARATUS
50 COMPUTER
51 NETWORK INTERFACE
52 PROCESSOR
53 MEMORY
100 NON-RT RIC
101 O1 COMMUNICATION UNIT
102 A1 COMMUNICATION UNIT
103 EXTERNAL COMMUNICATION UNIT
110 LEARNING DEVICE
111 LEARNING UNIT
112 MODEL STORAGE UNIT
120 EI DATA STORAGE UNIT
131 DATA COLLECTION UNIT
132 SCHEME DETERMINATION UNIT
133 DATA TRANSFER UNIT
134 SYSTEM MANAGEMENT UNIT
200 NEAR-RT RIC
201 E2 COMMUNICATION UNIT
202 O1 COMMUNICATION UNIT
203 A1 COMMUNICATION UNIT
210 INFERENCE DEVICE
211 INFERENCE UNIT
212 MODEL STORAGE UNIT
220 INFERENCE DATA STORAGE UNIT
231 DATA COLLECTION UNIT
232 DATA EXTRACTION UNIT
233 DATA TRANSFER UNIT
300 E2 NODE
400 EXTERNAL SERVER
500 SMO

What is claimed is:

1. A method comprising:
acquiring data provided from a data providing apparatus as inference data for another system to perform inference by an inference model; and
specifying, from among data including the acquired inference data, data collected from the other system that has performed inference by the inference model, as learning data for a learning model for constructing the inference model.

2. The method according to claim 1, further comprising transferring inference data acquired from the data providing apparatus to the other system, and
specifying whether the inference data transferred to the other system is collected from the other system.

3. The method system according to claim 2, further comprising storing the inference data transferred to the other system, and
specifying whether the stored inference data is collected from the other system.

4. The method system according to claim 3, further comprising synthesizing inference data stored in the storage means and data collected from the other system to generate learning data to be input to the learning model in a case where the inference data is not collected from the other system.

5. The method according to claim 1, further comprising specifying a route for collecting the learning data.

6. The method according to claim 1, further comprising specifying data to be collected from the other system based on a feature of the inference data acquired from the data providing apparatus.

7. The method according to claim 6, wherein the feature of the inference data includes a data size, the number of parameters, or a data acquisition cycle.

8. The method according to claim 6, further comprising acquiring inference data from the data providing apparatus a plurality of times, and specifying data collected from the other system according to a change in the inference data acquired the plurality of times.

9. The method according to claim 1, further comprising specifying data to be collected from the other system based on an input instruction.

10. The method according to claim 1, further comprising specifying data to be collected from the other system based on a load of a system including the system and the other system.

11. The method according to claim 1, wherein the data providing apparatus is a server outside a system including the system and the other system.

12. The method according to claim 1, wherein
the inference model infers control related to a radio network according to the inference data, and
the learning model learns control related to the radio network according to the learning data.

13. The method according to claim 1, wherein a system which performs the method and the other system include a radio access network (RAN) intelligent controller (RIC) that controls a RAN.

14. The method according to claim 13, wherein
the system includes a Non-RT (real time) RIC, and
the other system includes a Near-RT RIC.

15. A method comprising:
collecting data provided from a data providing apparatus as inference data for performing inference by an inference model; and
transmitting, as learning data for a learning model for constructing the inference model, data specified from among data including the collected inference data to another system that performs learning by the learning model.

16. The method according to claim 15, further comprising
collecting the inference data via the other system,
wherein the specified data is data specified by the other system.

17-18. (canceled)

19. A system comprising:
a memory configured to store instructions, and
a processor configured to execute the instructions to;
acquire data provided from a data providing apparatus as inference data for another system to perform inference by an inference model; and
specify, from among data including the acquired inference data, data collected from the other system that has performed inference by the inference model, as learning data for a learning model for constructing the inference model.

20-22. (canceled)
